(19) United States
(12) Patent Application Publication
(10) Pub. No.: US 2025/0328387 A1
(43) Pub. Date: Oct. 23, 2025

(54) DETERMINING A BLOCK SIZE ASSOCIATED WITH A TASK TO BE PROCESSED

(71) Applicant: Arm Limited, Cambridge (GB)

(72) Inventors: Gabriele VITIELLO, Cambridge (GB); Nils Ake Jonas OLSSON, Malmö (SE); Karl Patrik GUSTAVSSON, Lund (SE); Andreas Herman HANSSON, Lund (SE)

(21) Appl. No.: 18/639,714

(22) Filed: Apr. 18, 2024

(51) Int. Cl. G06F 9/50

(52) U.S. Cl. CPC G06F 9/5027

(57) ABSTRACT

A method of determining a block size associated with a task to be processed by a processing unit is disclosed. The task includes one or more operations. The method comprises, for the task, obtaining an ordered list of dimensions that represent a multidimensional operation space. The list of dimensions has a first dimension that has a higher impact on performance of the processing unit when loaded in sections from a storage medium of the processing unit during processing of the task by the processing unit than a last dimension in the list. The method comprises determining a block size by: identifying candidate block sizes by dividing the multidimensional operation space along the last dimension, determining whether each candidate block size meets a criterion related to a storage capacity of the storage medium, and selecting, from the one or more candidate block sizes, a block size meeting the criterion.

### BACKGROUND OF THE INVENTION

### Field of the Invention

The present invention relates to methods, systems, and non-transitory computer-readable storage media for determining a block size associated with a task to be processed by a processing unit.

### Description of the Related Technology

Preparation of data for processing a neural network may be desirable prior to processing by a processing unit, such as a neural processing unit, graphic processing unit or tensor processing unit. Preprocessing of neural networks for use on such processing units can involve several steps. The neural network may be subject to network pruning in which unnecessary nodes and connections are removed from the neural network. The goal of network pruning is to reduce the complexity of the neural network without significantly affecting its accuracy.

In some methods, quantization may be performed on the neural network. For example, a neural network may use 32-bit floating-point numbers for weights and biases. The weights and biases may be quantized into lower precision formats, such as 16-bit or 8-bit integers. This reduces the memory footprint and computational requirements of the model, possibly at the expense of accuracy.

It is desirable that the neural network and instructions for processing it be optimized considering the specific constraints and capabilities of the target processing unit. Accordingly, further optimization of data and instructions sent to a processing unit are desirable to improve performance of the processing unit when processing a neural network.

### SUMMARY

According to a first aspect there is provided a method of determining a block size associated with a task to be processed by a processing unit, wherein the task includes one or more operations, the method comprising: for the task, obtaining an ordered list of dimensions that represent a multidimensional operation space, wherein: each dimension of the multidimensional operation space relates to a dimension of an array of input or output data for an operation of the one or more operations, the list of dimensions are ordered in a predetermined order, and the list of dimensions has a first dimension that has a higher impact on performance of the processing unit when loaded in sections along the first dimension from a storage medium of the processing unit during processing of the task by the processing unit than a last dimension in the list; determining a block size by: identifying one or more candidate block sizes by dividing the multidimensional operation space along the last dimension, determining whether each candidate block size meets a criterion related to a storage capacity of the storage medium of the processing unit, and selecting, from the one or more candidate block sizes, a block size meeting the criterion; and encoding an indication of the selected block size into control data to allow the processing unit to retrieve portions of input data corresponding to input data included in a block in the multidimensional operation space obtained by traversing the multidimensional operation space with the selected block size.

According to a second aspect there is provided a system comprising a first processing unit, the first processing unit being configured to perform a method of determining a block size associated with a task to be processed by a second processing unit, wherein the task includes one or more operations, the method comprising: for the task, obtaining an ordered list of dimensions that represent a multidimensional operation space, wherein: each dimension of the multidimensional operation space relates to a dimension of an array of input or output data for an operation of the one or more operations, the list of dimensions are ordered in a predetermined order, and the list of dimensions has a first dimension that has a higher impact on performance of the second processing unit when loaded in sections along the first dimension from a storage medium of the second processing unit during processing of the task by the second processing unit than a last dimension in the list; determining a block size by: identifying one or more candidate block sizes by dividing the multidimensional operation space along the last dimension, determining whether each candidate block size meets a criterion related to a storage capacity of the storage medium of the second processing unit, and selecting, from the one or more candidate block sizes, a block size meeting the criterion; and encoding an indication of the selected block size into control data to allow the second processing unit to retrieve portions of input data corresponding to input data included in a block in the multidimensional operation space obtained by traversing the multidimensional operation space with the selected block size.

According to a third aspect there is provided a non-transitory computer-readable medium comprising instructions which, when executed by a first processing unit, cause the first processing unit to perform a method of determining a block size associated with a task to be processed by a second processing unit, wherein the task includes one or more operations, the method comprising: for the task, obtaining an ordered list of dimensions that represent a multidimensional operation space, wherein: each dimension of the multidimensional operation space relates to a dimension of an array of input or output data for an operation of the one or more operations, the list of dimensions are ordered in a predetermined order, and the list of dimensions has a first dimension that has a higher impact on performance of the second processing unit when loaded in sections along the first dimension from a storage medium of the second processing unit during processing of the task by the second processing unit than a last dimension in the list; determining a block size by: identifying one or more candidate block sizes by dividing the multidimensional operation space along the last dimension, determining whether each candidate block size meets a criterion related to a storage capacity of the storage medium of the second processing unit, and selecting, from the one or more candidate block sizes, a block size meeting the criterion; and encoding an indication of the selected block size into control data to allow the second processing unit to retrieve portions of input data corresponding to input data included in a block in the multidimensional operation space obtained by traversing the multidimensional operation space with the selected block size.

### BRIEF DESCRIPTION OF THE DRAWINGS

FIG. 1a illustrates an example directed acyclic graph in which sections are interconnected by a series of pipes;

FIG. 1b is a schematic diagram of a data processing system;

FIG. 2 is a schematic diagram of a neural engine;

FIG. 3 is a schematic diagram of a system for allocating data;

FIG. 4 is a flowchart showing steps of a method performed by the data processing system;

FIG. 5 is a flowchart showing a method for determining the block size associated with a task;

FIGS. 6a and 6b illustrate an example of the method for determining the block size associated with the task; and

FIGS. 7a and 7b illustrate a method for generating core-optimized block sizes.

### DETAILED DESCRIPTION OF CERTAIN INVENTIVE EMBODIMENTS

A compiler for a processing unit and a processing unit will be described below. The compiler is configured to determine a block size for use by the processing unit when processing data such as a neural network.

According to a first embodiment of the present invention, there is provided a method of determining a block size associated with a task to be processed by a processing unit, wherein the task includes one or more operations, the method comprising: for the task, obtaining an ordered list of dimensions that represent a multidimensional operation space, wherein: each dimension of the multidimensional operation space relates to a dimension of an array of input or output data for an operation of the one or more operations, the list of dimensions are ordered in a predetermined order, and the list of dimensions has a first dimension that has a higher impact on performance of the processing unit when loaded in sections along the first dimension from a storage medium of the processing unit during processing of the task by the processing unit than a last dimension in the list; determining a block size by: identifying one or more candidate block sizes by dividing the multidimensional operation space along the last dimension, determining whether each candidate block size meets a criterion related to a storage capacity of the storage medium of the processing unit, and selecting, from the one or more candidate block sizes, a block size meeting the criterion; and encoding an indication of the selected block size into control data to allow the processing unit to retrieve portions of input data corresponding to input data included in a block in the multidimensional operation space obtained by traversing the multidimensional operation space with the selected block size.

In some cases, the one or more candidate block sizes may be identified using a first set of one or more candidate lengths and a second set of one or more candidate lengths that are shorter than the candidate lengths in the first set. Identifying one or more candidate block sizes may comprise, for candidate lengths from the first set of one or more candidate lengths identifying a first set of candidate block sizes having the candidate length along the last dimension, and in response to determining that the first set of candidate block sizes do not meet the criterion, for the candidate lengths in the second set of one or more candidate lengths identifying a second set of candidate block sizes having the candidate length along the last dimension.

Identifying the first set of candidate block sizes may comprise identifying candidate block sizes having a candidate length from the first set of one or more candidate lengths by applying candidate lengths to successive dimensions in the list of dimensions from the last dimension to the first dimension. In such cases, the method may identify one or more candidate block sizes for a next dimension in the list of dimensions if the method determines that none of the current identified candidate block sizes meets the criterion related to a storage capacity of a storage medium of the processing unit.

In some cases, the method identifies the second set of candidate block sizes if the first set of candidate blocks sizes do not meet the criterion after candidate block sizes have been identified for all dimensions on the list of dimensions using the first set of one or more candidate lengths.

Each candidate length in the first set of one or more candidate lengths and the second set of one or more candidate lengths may be a power of two.

In some cases, a length of each dimension of the multidimensional operation space may be equal to a maximum dimension of a corresponding array of input or output data used in the operation of the one or more operations. The operation of the one or more operations may be an operation of the one or more operations that has a largest number of dimensions.

In some cases, selecting a block size meeting the criterion may comprise: simulating an execution of the task using one or more candidate block sizes meeting the criterion, to determine, for each candidate block size meeting the criterion, a processing performance parameter; and selecting, based on the processing performance parameters, a candidate block size as the block size.

The processing unit may comprise a plurality of processing cores. The storage medium may be one of a plurality of storage media belonging respectively to the processing cores. In such implementations, identifying the one or more candidate block sizes may comprise dividing the multidimensional operation space or the block size along a dimension from the list of dimensions based on the number of processing cores to determine one or more core-optimized candidate block sizes. Selecting the block size may comprise selecting one of the core-optimized candidate block sizes. In some cases, dividing the multidimensional operation space or block size comprises dividing the length of a dimension of the multidimensional operation space by the number of processing cores.

In some cases, the core-optimized candidate block sizes include block sizes obtained by dividing the multidimensional operation space or block size along two or more dimensions from the list of dimensions based on the number of processing cores.

In some cases, the task may be processing of at least a portion of a neural network. The operation of the one or more operations may be a convolution operation. In such cases, the first dimension on the list of dimensions may relate to a dimension of weight data.

The input data may comprise input feature map data and weight data for a neural network.

The predetermined order of the list of dimensions may be selected based on a type of the operation of the operation of the one or more operations included in the task.

In some cases, the criterion is whether input data included in the candidate block size can be processed by the processing unit without exceeding the storage capacity of the storage medium of the processing unit.

The task may form a graph comprising a plurality of operations.

In some cases, the method may comprise sending the control data to the processing unit.

According to a second embodiment of the present invention, there is provided a system comprising a first processing unit, the first processing unit being configured to perform a method according to the first embodiment.

According to a third embodiment of the present invention, there is provided a non-transitory computer-readable medium comprising instructions which, when executed by a first processing unit, cause the first processing unit to perform a method according to the first embodiment.

### Execution of a Directed Acyclic Graph (DAG)

A task for execution by a processing unit may be expressed in the form of a plurality of operations on data. Many data structures to be executed in a processing unit, such as a processor, can be expressed as a directed acyclic graph. Examples of such data structures include neural networks which can be represented as a directed acyclic graph of operations that wholly compose the operations required to execute a network (i.e. to execute the operations performed across the layers of a neural network). A directed acyclic graph is a data structure of operations (herein also referred to as ‘sections’) having directed connections therebetween that indicate a flow of operations such that those directed connections do not form a closed loop. The connections between operations (or sections) present in the graph of operations are also to referred herein as ‘pipes’. An acyclic graph may contain any number of divergent and convergent branches.

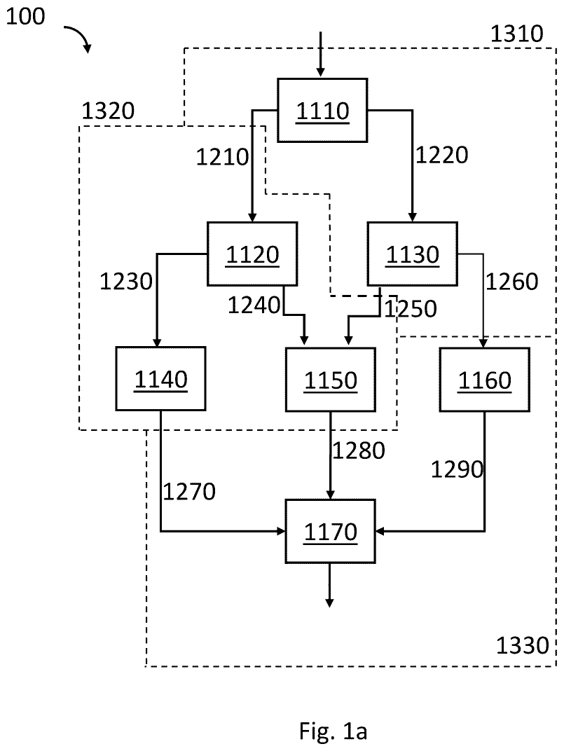

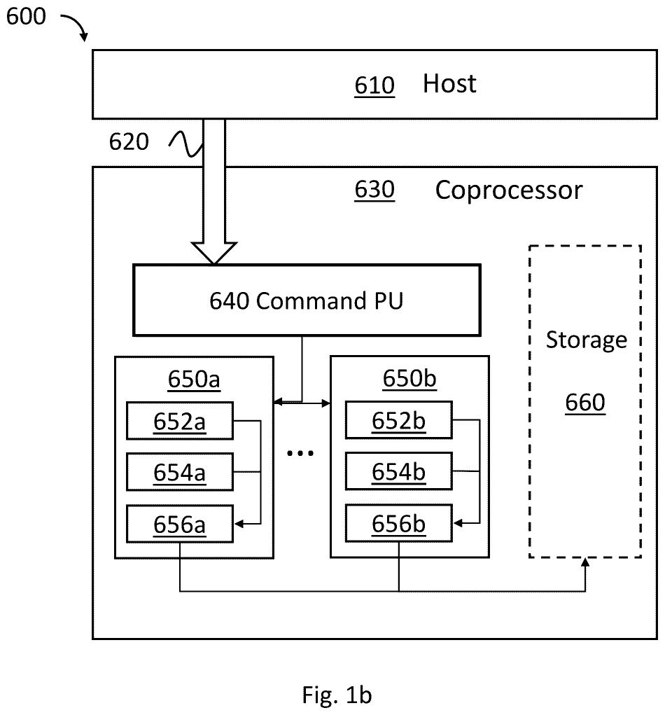

FIG. 1a illustrates an example directed acyclic graph 100 in which sections are interconnected by a series of pipes. Specifically, an initial section, section 1 (1110) represents a point in the acyclic graph at which an operation, operation A, is to be performed when executing the graph. The output of operation A at section 1, 1110, is connected to two further sections, section 2 (1120) and section 3 (1130) at which respective operations B and C are to be performed. The connection between section 1 (1110) and section 2 (1120) can be identified as a pipe with a unique identifier, pipe 1 (1210). The connection between section 1 (1110) and section 3 (1130) can be identified as a pipe with a different unique identifier, pipe 2 (1220). The output of section 1, which is the result of performing operation A on the input to section 1, can be provided to multiple subsequent sections in a branching manner.

More generally, sections in the acyclic graph may receive multiple inputs, each from a respective different section in the acyclic graph via a respective different pipe. For example, section 1150 in FIG. 1a receives a first set of input data via pipe 1240 from section 1120 and a second set of input data via pipe 1250. Depending on the nature of the operation performed in a particular section and the dependencies of subsequent operations on the output of the operation, any number of input and output pipes may be connected to a particular section in the acyclic graph.

The acyclic graph can be represented by a number of sub-graphs each containing a subset of the sections in the graph. FIG. 1a illustrates an arrangement where the graph 100 is broken down into three sub-graphs 1310, 1320, and 1330 which can be connected together to form the complete graph. For example, sub-graph 1310 contains sections 1110 and 1130 (as well as the corresponding pipes 1220 and 1260), sub-graph 1320 contains sections 1120, 1140, and 1150 (as well as corresponding pipes 1210, 1230, 1240 and 1250), and sub-graph 1330 contains sections 1160 and 1170 (as well as corresponding pipes 1270, 1280 and 1290).

The deconstruction of a graph 100 into sub-graphs is particularly useful when seeking to execute the graph since it would be possible to separately execute the sub-graphs which allows for parallelization of execution where there are no dependencies between sub-graphs. This can be particularly useful in a multi-processor environment where sub-graphs can be allocated for execution by different processors in the multi-processor environment. However, as shown in FIG. 1a sub-graph 1320 has a dependency on the execution of operation A and section 1110 and sub-graph 1330 has a dependency on sub-graph 1310. As such, execution of sub-graph 1330 may need to be stalled until sub-graph 1310 has been completed. It will therefore be appreciated that it is necessary to carefully select the appropriate sub-graph arrangement to maximise or improve the execution efficiency of the graph.

The operations performed when executing a neural network can be broken down into a sequence of operations forming an acyclic graph in the form described in respect of FIG. 1a. The detailed description herein will describe an arrangement for executing an acyclic graph of operations in an improved manner.

### Operation Space

When executing chains of operations, for example structured in a directed acyclic graph, each section could represent a different operation. It is not necessary for each operation to be of the same type or nature. This is particularly the case where the graph of operations is used to represent the processing of a neural network. The machine learning software ecosystem allows for a diverse structure of neural networks that are applicable to many different problem spaces, and as such there is a very large possible set of operations from which a neural network can be composed. The possible set of operations from which sections can be formed can be hard to manage when seeking to design hardware to enable the execution (also referred to as “acceleration”) of these operations—particularly when chained together. For example, enabling fixed-function operation of each possible type of operation can result in inefficient hardware by requiring support for obscure or complex operations (sections).

As a result, there are significant challenges in designing and building hardware capable of executing all types of neural networks created by the current machine learning toolsets. It is desirable to define a set of pre-determined low-level operations from which a broad range of possible higher-level operations that correspond with various machine learning tool sets can be built. One example of such a low-level set of operations, is the Tensor Operator Set Architecture (TOSA). The Tensor Operator Set Architecture (TOSA) provides a set of whole-tensor operations commonly employed by Deep Neural Networks. The intent is to enable a variety of implementations running on a diverse range of processors, with the results at the TOSA level consistent across those implementations. Applications or frameworks which target TOSA can therefore be deployed on a wide range of different processors, including single-instruction multiple-data (SIMD) CPUs, graphics processing units (GPUs) and custom hardware such as neural processing units/tensor processing units (NPUs/TPUs), with defined accuracy and compatibility constraints. Most operators from the common ML frameworks (TensorFlow, PyTorch, etc.) should be expressible in TOSA.

However, even with such operator sets existing, there is a need to implement the operator sets in a manner that can be executed efficiently, both in terms of complexity and while minimizing the need to perform external memory transactions. To enable this, it is useful to consider that many of the operations in a defined operation set (such as TOSA) can be represented as a loop of scalar operations.

For example, consider a 2D convolution operation which can be expressed as a multi-dimensional loop of scalar operations. These may need to be executed on input 2D input data having dimensions input X (IX) and input Y (IY):
(input) Input channel (IC)—a dimension representing the input channels upon which the operation is to be performed (in the example of images this may be three channels each representing one of red, green, and blue input channels)
(input) Kernel dimension X (KX)—a first dimension X of a 2D kernel;
(input) Kernel dimension Y (KY)—a second dimension Y of a 2D kernel;
(output) Output X (OX)—a first dimension of the output feature map for the convolution operation;
(output) Output Y (OY)—a second dimension of the output feature map for the convolution operation;
(output) Batch (N)—a batch dimension of the operation, where the operation is to be batched;
(output) Output channel (OC)—a dimension representing the output channels to be produced for the 2D convolution operation.

In one proposed ordering, KY/KX can be considered the inner-most dimensions and OC is the outer-most dimension.

For the 2D convolution operation example above, it is possible to express the operation to be performed as a “nested for-loop” of scalar operations as is illustrated in the pseudocode set out below. In practice, when executing this operation, it is necessary for a processor to execute the operation across each of these dimensions by performing a multiply accumulate operation (MAC), the result of which is then written into an accumulator (e.g. an accumulator buffer in hardware). Having iterated through all of these dimensions, the 2D convolution is completed and the contents of the accumulator therefore represents the result of the 2D convolution operation across the entire dimensionality of operation.

```
For(output channel)
  for(batch N)
    for(output Y)
      for(output X)
        for(input channel)
          for(kernel Y)
            for(kernel X)
              MAC
              write accumulator
```

The seven dimensions of the convolution operation can collectively be used to define the ‘operation space’ in which the 2D convolution operation is to be performed. More specifically, the sizes of each dimension can be used to define an effective “bounding box” defining the size, the number of elements in each dimension, of the operation space upon which the operation is to be performed. To illustrate this in more detail, consider an example where a 3×3 (i.e. KX=3; KY=3) convolution operation having padding is to be performed on input data having dimension IX=15; IY=15; N=1; and IC=32. This operation results in the following minimum and maximum index values representing the upper and lower bounds inclusive (i.e. the size) of the dimensionality of the convolution operation as shown in Table 1:

TABLE 1

| | OC | N | OY | OX | IC | KY | KX |
|---|---|---|---|---|---|---|---|
| Min | 0 | 0 | 0 | 0 | 0 | 0 | 0 |
| Max | 63 | 0 | 14 | 14 | 31 | 2 | 2 |

The output of the 2D convolution operation would have dimensions N=1; OY=15; OX=15; OC=64. These values represent the size of the output of the 2D convolution operation but they do not alone wholly represent the size of the operation required to generate that output. To wholly represent the operation space of the operation, all of the dimensions of the operation are required as shown in the above table. A shorthand representation for the dimensions of the 2D convolution operation is [OC N OY OX IC KY KX] and in this specific example can be presented as the minimum and maximum index values as illustrated in the example above i.e. [64 1 15 15 32 3 3].

Operations such as the convolution operation described above can be separated into blocks, each block representing a subset of an operation in which each dimension of the block covers a subset of the full range of the corresponding dimension in the operation. In the example below, the 2D convolution of Table 1 is separated into multiple blocks by breaking up the operation in the OY, OX, and IC dimensions. Breaking the operation into blocks involves separating the operation space of the operation into multiple blocks which each individually represent a portion of the operation but collectively represent the operation space. This block generation involves separating the operation space into sub-blocks representing a non-overlapping subset of the dimensions in the operation space which wholly cover the operation space dimensions (e.g. the set of nested for-loops shown above). In an example where the operation is to be separated into a number of blocks, the operation space is broken down into sub-blocks based upon a pre-determined block-size which defines for each dimension of the operation a fixed size. In the example below, the block size is as follows:

TABLE 2

| | OC | N | OY | OX | IC | KY | KX |
|---|---|---|---|---|---|---|---|
| Block size | 16 | 1 | 8 | 8 | 16 | 3 | 3 |

In the block size above, the operation space is broken up by separating four of the seven dimensions of the operation in two. In the examples below, OY, OX, and IC have been separated into two, while OC has been separated into four. The following blocks illustrate a portion of the blocks that wholly represent the operation space (with only a first quarter of the OC dimension being represented):

TABLE 3

| | OC | N | OY | OX | IC | KY | KX |
|---|---|---|---|---|---|---|---|
| Block #0 | | | | | | | |
| Min | 0 | 0 | 0 | 0 | 0 | 0 | 0 |
| Max | 15 | 0 | 7 | 7 | 15 | 2 | 2 |
| Block #1 | | | | | | | |
| Min | 0 | 0 | 0 | 0 | 16 | 0 | 0 |
| Max | 15 | 0 | 7 | 7 | 31 | 2 | 2 |
| Block #2 | | | | | | | |
| Min | 0 | 0 | 0 | 8 | 0 | 0 | 0 |
| Max | 15 | 0 | 7 | 14 | 15 | 2 | 2 |
| Block #3 | | | | | | | |
| Min | 0 | 0 | 0 | 8 | 16 | 0 | 0 |
| Max | 15 | 0 | 7 | 14 | 31 | 2 | 2 |
| Block #4 | | | | | | | |
| Min | 0 | 0 | 8 | 0 | 0 | 0 | 0 |
| Max | 15 | 0 | 14 | 7 | 15 | 2 | 2 |
| Block #5 | | | | | | | |
| Min | 0 | 0 | 8 | 0 | 16 | 0 | 0 |
| Max | 15 | 0 | 14 | 7 | 31 | 2 | 2 |
| Block #6 | | | | | | | |
| Min | 0 | 0 | 8 | 8 | 0 | 0 | 0 |
| Max | 15 | 0 | 14 | 14 | 15 | 2 | 2 |
| Block #7 | | | | | | | |
| Min | 0 | 0 | 8 | 8 | 16 | 0 | 0 |
| Max | 15 | 0 | 14 | 14 | 31 | 2 | 2 |

For a given block of the operation space, e.g. [OC N OY OX IC KY KX], it is possible to determine which input feature map coordinates are required to perform the operation for that block. In the example of the 2D convolution operation, the input feature map coordinates (and other input parameters) upon which the output feature map coordinates depend can be defined as the below (stride X, Y=1 (i.e. no striding); dilation X, Y=1 (i.e. no dilation) and top, left pad=1 (i.e. the input is padded):

$$N = N ; ( wherein N is batch number ) ;$$

$$IY = ( OY * ( Stride Y ) ) + ( ( Dilation Y ) * KY ) - Top Pad ;$$

$$IX = ( OX * ( Stride X ) ) + ( ( Dilation X ) * KX ) - Left Pad ;$$

$$and$$

$$IC = IC ;$$

Where Stride X and Stride Y, Dilation X, and Dilation Y represent the respective stride and dilation values in X and Y dimensions when executing the convolution operation, and where Top Pad and Left Pad represent respective top and left padding values when executing the operation. When the above relationships are simplified for stride and dilation values of 1 with zero padding, this can more simply be expressed as [N, OY+KY−1, OX+KX−1, IC]. These expressions for calculating the input feature maps for processing a block can be represented as an affine transform as set out below in table 4:

TABLE 4

| | OC | N | OY | OX | IC | KY | KX | Offset |
|---|---|---|---|---|---|---|---|---|
| N | | 1 | | | | | | |
| IY | | | 1 | | | 1 | | −1 |
| IX | | | | 1 | | | 1 | −1 |
| IC | | | | | 1 | | | |
| | | | | | | | | 1 |

For a given block in operation space it is therefore possible to express a transform (an affine or semi-affine transform) to transform the block to determine the input feature map coordinate ranges needed for performing the operation as defined by the block. In the example of the above affine transform being applied to Block #2, the resultant input range of input feature map indexes can be shown to be as below in Table 5:

TABLE 5

| | Min | Max |
|---|---|---|
| N | 0 | 0 |
| IY | −1 | 8 |
| IX | 7 | 15 |
| IC | 0 | 15 |

The affine transform defined above can be used to separately represent the transforms required to define each of the input feature map (as set out above), the output feature map, and the weights. General examples of each of input feature map, output feature map, and weight transforms is set out in Tables 6 to 8 below:

TABLE 6
Input transform for 2D convolution

| IFM | OC | N | OY | OX | IC | KY | KX | Offset |
|---|---|---|---|---|---|---|---|---|
| N | | 1 | | | | | | |
| IY | | | Stride Y | | | Dilation Y | | Top Pad |
| IX | | | | Stride X | | | Dilation X | Left Pad |
| IC | | | | | 1 | | | |
| | | | | | | | | 1 |

TABLE 7
Weight transform for 2D convolution

| | | | | | | | | |
|---|---|---|---|---|---|---|---|---|
| Weights | OC | N | OY | OX | IC | KY | KX | Offset |

| | | | | | |
|---|---|---|---|---|---|
| OC | 1 | | | | |
| KY | | | 1 | | |
| KX | | | | 1 | |
| IC | | 1 | | | |
| | | | | | 1 |

TABLE 8
Output transform for 2D convolution

| OFM | OC | N | OY | OX | IC | KY | KX | Offset |
|---|---|---|---|---|---|---|---|---|
| N | | 1 | | | | | | |
| OY | | | 1 | | | | | |
| OX | | | | 1 | | | | |
| OC | 1 | | | | | | | |
| | | | | | | | | 1 |

It will be appreciated therefore that the operation space defines the dimensionality of the operations to be performed when executing a particular operation. The above examples are provided in respect of a 2D convolution but the concept is applicable to all types of operation that is to be performed. For example, similar transforms for the input and output of a transpose operation (e.g. transposing dimensions {0,1,3,2}) can be derived as set out below:

TABLE 9
Input transform for {0, 1, 3, 2} transpose

| Input | Dim 0 | Dim 1 | Dim 2 | Dim 3 | Offset |
|---|---|---|---|---|---|
| Dim 0 | 1 | | | | |
| Dim 1 | | 1 | | | |
| Dim 2 | | | | 1 | |
| Dim 3 | | | 1 | | |
| | | | | | 1 |

TABLE 10
Output transform for {0, 1, 3, 2} transpose

| Output | Dim 0 | Dim 1 | Dim 2 | Dim 3 | Offset |
|---|---|---|---|---|---|
| Dim 0 | 1 | | | | |
| Dim 1 | | 1 | | | |
| Dim 2 | | | 1 | | |
| Dim 3 | | | | 1 | |
| | | | | | 1 |

Utilising the input transform on the input allows the swapping of dimensions 2 and 3 in the input transform matrix to perform the transpose operation. More generally, the input and output matrices can then be applied to a block in operation space to determine a range of values for the input and output of that operation. These determined ranges of values represent the local section space for that operation, which forms a local coordinate system on which that operation can be executed for that block of the operation space.

When considering the acylic graph data structure described above in respect of FIG. 1a, the operation performed in each section of the graph can be defined by the set of input and output transform matrices for that operation. It is therefore possible to represent at least a portion of the acyclic graph by a chain of operations that correspond to a chain of sections each connected by pipes. In addition, an operation space for a chain of operations can be established.

### Hardware Implementation

As described above, a data structure in the form of a directed acyclic graph may comprise plural sequenced operations that are connected to one another for execution in a chain. Described below is an example hardware arrangement for executing chained operations for at least a portion of a directed acyclic graph as illustrated in FIG. 1a.

FIG. 1b shows schematically an example of a data processing system 600 including a data processing unit in the form of a processor 630 which may act as a co-processor or hardware accelerator unit for a host processing unit 610. It will be appreciated that the types of hardware accelerator which the processor 630 may provide dedicated circuitry for is not limited to that of Neural Processing Units (NPUs) or Graphics Processing units (GPUs) but may be dedicated circuitry for any type of hardware accelerator. GPUs may be well-suited for performing certain types of arithmetic operations such as neural processing operations, as these operations are generally similar to the arithmetic operations that may be required when performing graphics processing work (but on different data formats or structures). Furthermore, GPUs typically support high levels of concurrent processing (e.g. supporting large numbers of execution threads), and are optimized for data-plane (rather than control plane) processing, all of which means that GPUs may be well-suited for performing other types of operations.

That is, rather than using entirely separate hardware accelerators, such as a machine learning processing unit that is independent of the graphics processor, such as an NPU, or only being able to perform machine learning processing operations entirely using the hardware of the GPU, dedicated circuitry may be incorporated into the GPU itself.

This means that the hardware accelerator circuitry incorporated into the GPU is operable, to utilize some of the GPU's existing resources (e.g. such that at least some functional units and resource of the GPU can effectively be shared between the different hardware accelerator circuitry, for instance), whilst still allowing an improved (more optimized) performance compared to performing all the processing with general purpose execution.

As such, the processor 630 may be a GPU that is adapted to comprise a number of dedicated hardware resources, such as those which will be described below.

In some examples, this can be particularly beneficial when performing machine learning tasks that themselves relate to graphics processing work, as in that case all of the associated processing can be (and preferably is) performed locally to the graphics processor, thus improving data locality, and (e.g.) reducing the need for external communication along the interconnect with other hardware units (e.g. an NPU). In that case, at least some of the machine learning processing work can be offloaded to the machine learning processing circuit, thereby freeing the execution unit to perform actual graphics processing operations, as desired.

In other words, in some examples, providing a machine learning processing circuit within the graphics processor, this means that the machine learning processing circuit is preferably then operable to perform at least some machine learning processing operations whilst the other functional units of the graphics processor are simultaneously performing graphics processing operations. In the situation where the machine learning processing relates to part of an overall graphics processing task this can therefore improve overall efficiency (in terms of energy efficiency, throughput, etc.) for the overall graphics processing task.

In FIG. 1b, the processor 630 is arranged to receive a command stream 620 from a host processor 610, such as a central processing unit (CPU). The command stream 620 comprises at least one command in a given sequence, each command to be executed, and each command may be decomposed into a number of tasks, such as tasks discussed in this document. These tasks may be self-contained operations, such as a given machine learning operation or a graphics processing operation. It will be appreciated that there may be other types of tasks depending on the command.

The command stream 620 is sent by the host processor 610 and is received by a command processing unit 640 which is arranged to schedule the commands within the command stream 620 in accordance with their sequence. The command processing unit 640 is arranged to schedule the commands and decompose each command in the command stream 620 into at least one task. Once the command processing unit 640 has scheduled the commands in the command stream 620, and generated a plurality of tasks for the commands, the command processing unit 640 issues each of the plurality of tasks to at least one compute unit 650a, 650b each of which are configured to process at least one of the plurality of tasks.

The processor 630 comprises a plurality of compute units 650a, 650b. Each compute unit 650a, 650b, may be a shader core of a GPU specifically configured to undertake a number of different types of operations, however it will be appreciated that other types of specifically configured processor may be used, such as a general-purpose processor configured with individual compute units, such as compute units 650a, 650b. Each compute unit 650a, 650b comprises a number of components, and at least a first processing module 652a, 652b for executing tasks of a first task type, and a second processing module 654a, 654b for executing tasks of a second task type, different from the first task type. In some examples, the first processing module 652a, 652b may be a processing module for processing neural processing operations, such as those which would normally be undertaken by a separate NPU. In these cases, the first processing module 652a, 652b is for example a neural engine. Similarly, the second processing module 654a, 654b may be a processing module for processing graphics processing operations forming a set of pre-defined graphics processing operations which enables the implementation of a graphics processing pipeline, which may be referred to as a graphics processor. For example, such graphics processing operations include a graphics compute shader task, a vertex shader task, a fragment shader tasks, a tessellation shader task, and a geometry shader task. These graphics processing operations may all form part of a set of pre-defined operations as defined by an application programming interface, API. Examples of such APIs include Vulkan, Direct3D and Metal. Such tasks would normally be undertaken by a separate/external GPU. It will be appreciated that any number of other graphics processing operations may be capable of being processed by the second processing module.

As such, the command processing unit 640 issues tasks of a first task type to the first processing module 652a, 652b of a given compute unit 650a, 650b, and tasks of a second task type to the second processing module 654a, 354b of a given compute unit 650a, 650b. The command processing unit 640 would issue machine learning/neural processing tasks to the first processing module 652a, 652b of a given compute unit 650a, 650b where the first processing module 652a, 652b is optimized to process neural network processing tasks, for example by comprising an efficient means of handling a large number of multiply-accumulate operations. Similarly, the command processing unit 640 would issue graphics processing tasks to the second processing module 654a, 654b of a given compute unit 650a, 650b where the second processing module 652a, 654a is optimized to process such graphics processing tasks. In some examples, the first and second may both be neural processing tasks issued to a first processing module 652a, 652b, which is a neural engine. Such a neural processing task may involve the processing of a tensor, e.g. representing a feature map, with weights associated with a layer of a neural network.

In addition to comprising a first processing module 652a, 652b and a second processing module 654a, 654b, each compute unit 650a, 650b also comprises a memory in the form of a local cache 656a, 656b for use by the respective processing module 652a, 652b, 654a, 654b during the processing of tasks. Examples of such a local cache 656a, 656b is a L1 cache. The local cache 656a, 656b may, for example, a synchronous dynamic random-access memory (SDRAM). For example, the local cache 656a, 656b may comprise a double data rate synchronous dynamic random-access memory (DDR-SDRAM). It will be appreciated that the local cache 656a, 656b may comprise other types of memory.

The local cache 656a, 656b is used for storing data relating to the tasks which are being processed on a given compute unit 650a, 650b by the first processing module 652a, 652b and second processing module 654a, 654b. It may also be accessed by other processing modules (not shown) forming part of the compute unit 650a, 650b the local cache 656a, 656b is associated with. However, in some examples, it may be necessary to provide access data associated with a given task executing on a processing module of a given compute unit 650a, 650b to a task being executed on a processing module of another compute unit (not shown) of the processor 630. In such examples, the processor 630 may also comprise L2 cache 660, for example a cache, such as an L2 cache, for providing access to data use for the processing of tasks being executed on different compute units 650a, 650b.

By providing a local cache 656a, 656b tasks which have been issued to the same compute unit 650a, 650b may access data stored in the local cache 656a, 656b, regardless of whether they form part of the same command in the command stream 620. The command processing unit 640 is responsible for allocating tasks of commands to given compute units 650a, 650b such that they can most efficiently use the available resources, such as the local cache 656a, 656b, thus reducing the number of read/write transactions required to memory external to the compute units 650a, 650b, such as the L2 cache 660 (L2 cache) or higher level memories. One such example, is that a task of one command issued to a first processing module 652a of a given compute unit 650a, may store its output in the local cache 656a such that it is accessible by a second task of a different (or the same) command issued to a given processing module 652a, 654a of the same compute unit 650a.

One or more of the command processing unit 640, the compute units 650a, 650b, and the L2 cache 660 may be interconnected using a bus. This allows data to be transferred between the various components. The bus may be or include any suitable interface or bus. For example, an ARM® Advanced Microcontroller Bus Architecture (AMBA®) interface, such as the Advanced extensible Interface (AXI), may be used.

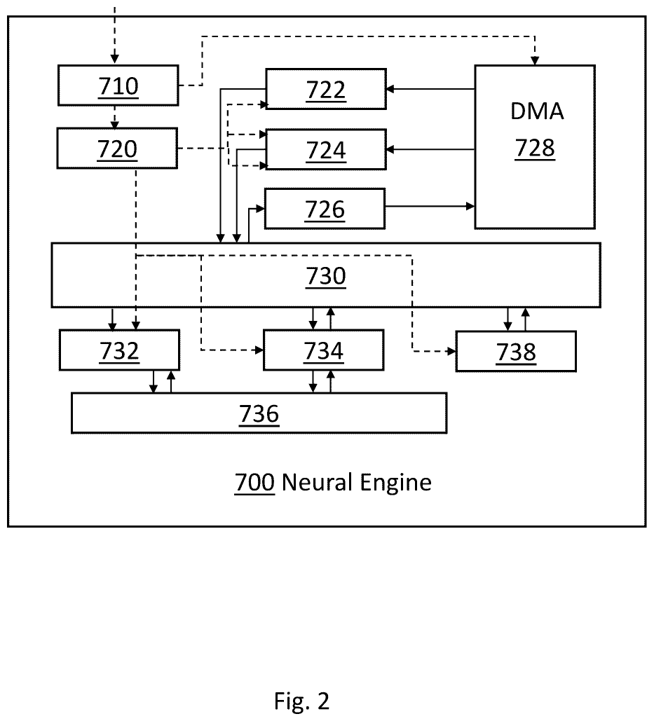

FIG. 2 is a schematic diagram of a neural engine 700, which in this example is used as a first processing module 652a, 652b in a data processing system 600 in accordance with FIG. 1b. The neural engine 700 includes a command and control module 710. The command and control module 710 receives tasks from the command processing unit 640 (shown in FIG. 1b), and also acts as an interface to storage external to the neural engine 700 (such as a local cache 656a, 656b and/or a L2 cache 660) which is arranged to store data to be processed by the neural engine 700 such as data representing a tensor, or data representing a stripe of a tensor. In the context of the present disclosure, a stripe is a subset of a tensor in which each dimension of the stripe covers a subset of the full range of the corresponding dimension in the tensor. The external storage may additionally store other data to configure the neural engine 700 to perform particular processing and/or data to be used by the neural engine 700 to implement the processing such as neural network weights.

The command and control module 710 interfaces to a handling unit 720, which is for example a traversal synchronization unit (TSU). In this example, each task corresponds to a stripe of a tensor which is to be operated upon in accordance with a sequence of operations according to at least a portion (e.g. a sub-graph) of the acyclic graph representation of the neural network. The tensor for example represents a feature map for processing using the neural network. A neural network typically includes a sequence of layers of processing, with an output from each layer being used as an input to the next layer. Each layer for example processes an input feature map by operating upon the input feature map to generate an output feature map, which is used as the input feature map for the next layer. The term “feature map” is used generically herein to refer to either an input feature map or an output feature map. The processing performed by a given layer may be taken to correspond to an operation.

In this example, the handling unit 720 splits data representing a stripe of a feature map into a plurality of blocks of data, each of which represents a respective part of the feature map. The handling unit 720 also obtains, from storage external to the neural engine 700 such as the L2 cache 660, task data defining operations selected from an operation set comprising a plurality of operations. In this example, the operations are structured as a chain of operations representing a sequence of layers of the neural network. A block of data is allocated as an input to one of the operations by the handling unit 720.

The handling unit 720 coordinates the interaction of internal components of the neural engine 700, which include a weight fetch unit 722, an input reader 724, an output writer 726, a direct memory access (DMA) unit 728, a dot product unit (DPU) array 730, a vector engine 732, a transform unit 734, an accumulator buffer 736, and a storage 738, for processing of blocks of data. The data dependencies across the functional units are tracked by the handling unit 720. Processing is initiated by the handling unit 720 in a functional unit if all input blocks are available and space is available in the storage 738 of the neural engine 700. The storage 738 may be considered to be a shared buffer, in that various functional units of the neural engine 700 share access to the storage 738.

In the context of a directed acyclic graph representing the operations to be performed, each of the internal components that operates upon data can be considered to be one of two types of component. The first type of component is an execution unit (and is identified within the neural engine 700 as such) that maps to a section that performs a specific instance of an operation within the acyclic graph. For example, the weight fetch unit 722, input reader 724, output writer 726, dot product unit array 730, vector engine 732, transform unit 734 each are configured to perform one or more pre-determined and fixed operations upon data that it receives. Each of these sections can be uniquely identified with an identifier and each execution unit can also be uniquely identified.

Similarly, all physical storage elements within the neural engine (and in some instances portions of those physical storage elements) can be considered to be uniquely identified within the neural engine. The connections between sections in the acyclic graph representing the neural network are also referred to as pipes within the context of the acyclic graph. These pipes can also be mapped to the uniquely identified physical storage elements in the neural engine. For example, the accumulator buffer 736 and storage 738 (and portions thereof) can each be regarded as a storage element that can act to store data for a pipe within the acyclic graph. The pipes act as connections between the sections (as executed by execution units) to enable a sequence of operations as defined in the acyclic graph to be chained together within the neural engine 700. Put another way, the logical dataflow of the acyclic graph can be mapped to the physical arrangement of execution units and storage elements within the neural engine 700. Under the control of the handling unit 720, execution can be scheduled on the execution units and data can be passed between the execution units via the storage elements in accordance with the mapping, such that the chained operations of a graph can be executed without needing to write data memory external to the neural engine 700 between executions. The handling unit 720 is configured to control and dispatch work representing performing an operation of the graph on at least a portion of the data provided by a pipe.

The weight fetch unit 722 fetches weights associated with the neural network from external storage and stores the weights in the storage 738. The input reader 724 reads data to be processed by the neural engine 700 from external storage, such as a block of data representing part of a tensor. The output writer 726 writes data obtained after processing by the neural engine 700 to external storage. The weight fetch unit 722, input reader 724 and output writer 726 interface with the external storage (which is for example the local cache 656a, 656b, which may be a L1 cache such as a load/store cache) via the DMA unit 728.

Data is processed by the dot-product unit (DPU) array 730, vector engine 732 and transform unit 734 to generate output data corresponding to an operation in the acyclic graph. The result of each operation is stored in a specific pipe within the neural engine 700. The DPU array 730 is arranged to perform one or more operations associated with a dot product operation between two operands, such as between an array of weights and a corresponding block of data (e.g. representing part of a tensor). The vector engine 732 is arranged to perform elementwise operations, for example to apply scale parameters to scale an output of a dot product calculated by the DPU array 730. Data generated during the course of the processing performed by the DPU array 730 and the vector engine 732 may be transmitted for temporary stage in the accumulator buffer 736 which acts as a pipe between the previous operation and the subsequent operation, from where it may be retrieved by either the DPU array 730 or the vector engine 732 (or another different execution unit) for further processing as desired.

The DPU array 730 contains a fixed number of dot product units, each configured to perform said dot product operations between a portion of an array of weights and corresponding input feature map data. In some cases, the block processed by the neural engine 700 is sufficiently large that the number of dot product units required to collectively and simultaneously perform the dot product operation exceeds the number of dot product units that are available in the DPU array 730. In such cases, during processing of an operation requiring use of the DPU array 730, the DPU array 730 may be used to perform dot product operations between a first portion of the array of weights and a first portion of the input feature map data, and following this, the output writer 726 writes output data obtained from this operation to the DMA 728. Subsequently, the weight fetch unit 722 and the input reader 724 retrieve respectively a second portion of the array of weights and a second portion of the input feature map data. The DPU array 730 then performs dot product operations between these second portions, and the output writer 726 can write output data obtained from this operation to the DMA 728.

It should be observed that, as a result of the limited number of dot product units in the DPU array 730, the processing of a single block of data by the neural engine 700 has to be performed in successive stages. The same issue may occur due to the limited capacity of other components (e.g. the vector engine 732) in the neural engine 700, even if the DMA 728 has sufficient memory capacity to store all of the inputs, weights and outputs for the operation at one time. Accordingly, the dimensions of the input data determined by the block size can have an Impact on performance of the coprocessor 630.

The transform unit 734 is arranged to perform in-block transforms such as dimension broadcasts or axis swaps. The transform unit 734 obtains data from a pipe, such as storage 738 (e.g. after processing by the DPU array 730 and/or vector engine 732), and writes transformed data back to the storage 738.

To make efficient use of the storage 738 available within the neural engine 700, the handling unit 720 determines an available portion of the storage 738, which is available during execution of part of a first task (e.g. during processing of a block of data associated with the first task by the DPU array 730, vector engine 732 and/or transform unit 734). The handling unit 720 determines a mapping between at least one logical address associated with data generated during execution of a second task (e.g. by processing of a block of data associated with the second task by the DPU array 730, vector engine 732 and/or transform unit 734) and at least one physical address of the storage 738 corresponding to the available portion. The logical address is for example a global address in a global coordinate system. Hence, by altering the physical address corresponding to a given logical address, the handling unit 720 can effectively control usage of the storage 738 without requiring a change in software defining the operation to be performed, as the same logical address can still be used to refer to a given element of the tensor to be processed. The handling unit 720 identifies the at least one physical address corresponding to the at least one logical address, based on the mapping, so that data associated with the logical address is stored in the available portion. The handling unit 720 can perform the mapping process according to any of the examples herein.

It will be appreciated that in a graph of operations there does not need to be only a single instance of a particular type of operation. For example, multiple instances of a convolution operation could be present in a graph of operations. In the above example hardware arrangement only a single convolution engine may be present. Therefore, it will be appreciated that there does not need to be a direct 1:1 mapping between operations in the graph (sections) and execution units, and similarly no direct 1:1 mapping between pipes and storage elements. In particular, a single execution unit may be configured at different instances in time to execute different instances of a convolution operation (e.g. first and second sections). Similarly, the input reader may be required to read data as part of different sections in the graph. The same can be said for storage elements and pipes.

All storage in the neural engine 700 may be mapped to corresponding pipes, including look-up tables, accumulators, etc. Some storage may be relatively fixed purpose, for example, if the hardware were limited to one convolution operation per graph the accumulator buffer might also be limited to being mapped to one pipe, and scale/bias/shift buffer might be limited to being mapped to one pipe; however both would likely be double buffered. If the neural engine supports 2 look-up tables (LUTs), then a maximum of 2 pipes could be used to target the LUTs to avoid needing to thrash the LUT storage; LUT pipes might then be single buffered. All other pipes could be mapped to a common Shared Buffer (or portions thereof) with fewer restrictions. Width and height of pipe can also be programmable, resulting a highly configurable mapping between pipes and storage elements within the neural engine 700.

Ordering of execution of the sections is implied by dependencies on inputs. A memory load operation has no data dependencies (unless it is a gather operation), so is implicitly early in the graph. The consumer of the pipe the memory read produces is implicitly after the memory read. A memory store operation is near the end of the graph, as it produces no pipes for other operations to consume.

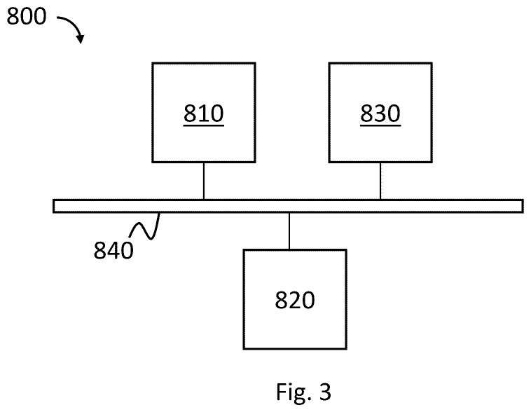

FIG. 3 shows schematically a system 800 for allocating data, and in some examples generating a plurality of blocks of input data for processing.

The system 800 comprises host processor 810 such as a central processing unit, or any other type of general processing unit. The host processor 810 issues a command stream comprising a plurality of commands, each having a plurality of tasks associated therewith.

The system 800 also comprises a processor 830, which may be similar to or the same as the processor 630 of FIG. 1b, and may comprise at least some of the components of and/or be configured to perform the methods described above. The processor 830 comprises at least a plurality of compute units 650a, 650b and a command processing unit 640. Each compute unit may comprise a plurality of processing modules each configured to perform at least one type of operation. The system 800 may also include at least one further processor (not shown), which may be the same as the processor 830. The processor 830, and the host processor 810 may be combined as a System on Chip (SoC) or onto multiple SoCs to form one or more application processors.

The system 800 also comprises memory 820 for storing data generated by the tasks externally from the processor 830, such that other tasks operating on other processors may readily access the data. However, it will be appreciated that the external memory usage will be used sparingly, due to the allocation of tasks as described above, such that tasks requiring the use of data generated by other tasks, or requiring the same data as other tasks, will be allocated to the same compute unit 650a, 650b of a processor 830 so as to maximize the usage of the local cache 656a, 656b.

In some examples, the system 800 may comprise a memory controller (not shown), which may be a dynamic memory controller (DMC). The memory controller is coupled to the memory 820. The memory controller is configured to manage the flow of data going to and from the memory. The memory may comprise a main memory, otherwise referred to as a ‘primary memory’. The memory may be an external memory, in that the memory is external to the system 800. For example, the memory 820 may comprise ‘off-chip’ memory. The memory may have a greater storage capacity than local caches of the processor 830 and/or the host processor 810. In some examples, the memory 820 is comprised in the system 800. For example, the memory 820 may comprise ‘on-chip’ memory. The memory 820 may, for example, comprise a magnetic or optical disk and disk drive or a solid-state drive (SSD). In some examples, the memory 820 comprises a synchronous dynamic random-access memory (SDRAM). For example, the memory 820 may comprise a double data rate synchronous dynamic random-access memory (DDR-SDRAM).

One or more of the host processor 810, the processor 830, and the memory 820 may be interconnected using a system bus 840. This allows data to be transferred between the various components. The system bus 840 may be or include any suitable interface or bus. For example, an ARM® Advanced Microcontroller Bus Architecture (AMBA®) interface, such as the Advanced extensible Interface (AXI), may be used.

### Neural Engine Program Descriptor (NED)

The neural engine 700 receives tasks from the command processing unit 640 to execute operations from the acyclic graph. The neural engine 700 is configured to execute operations selected from a base set of operations defining an operator set. One example of such an operator set is the Tensor Operator Set Architecture (TOSA) base inference profile, which defines a set of operations that can collectively be used to define the operations of a wide range of neural network operations. One exception to the TOSA operator set is control flow operations that may be implemented by way of a command stream processed by the command processing unit 640. It will be appreciated that there may be multiple neural engines with the processor 630 and thus multiple tasks can be issued concurrently to different neural engines.

In an example implementation, a task issued by the command processing unit 640 for execution by the neural engine 700 is described by task data which in this example is embodied by a neural engine program descriptor (NED), which is a data structure stored in memory and retrieved by the neural engine when executing the task issues by the command processing unit. The NED for a task describes at least a portion of a complete graph of operations (sections) to be performed when executing the graph of operations (e.g. representing a neural network). As discussed above, sections are mapped to various hardware execution units within the neural engine 700 and essentially represent instantiations of a particular operator at a position within the graph. In one example, these sections are described by specific ‘elements’ that collectively define the operations forming part of the NED. Furthermore, the NED has an unordered list of pipes (graph vertices) and an unordered list of sections/operations (graph nodes). Each operation specifies its input and output pipes giving rise to adjacency of operation in the acyclic graph to which a particular operation is connected.

An example NED comprises a NED structure comprising a header, the elements each corresponding to a section in the graph. The NED describes the various requirements of ordering, number and relationship of these sections and pipes. In one implementation, each of the execution units and each storage element (or portion of a storage element) of the neural engine 700 has a sub-descriptor definition which defines how that execution unit/storage element can be configured for use in implementing a specific section or pipe in the graph. An example of the hardware units and their corresponding elements is set out below:
Weight Fetch (WF): NEDWeightFetchElement
Input Reader (IR): NEDInputReaderElement
Output Writer (OW): NEDOutputWriterElement
Convolution Engine (CE): NEDConvolutionEngineElement
Transform Unit (TU): NEDTransformUnitElement
Vector Engine (VE): NEDVectorEngineElement

The NED therefore may specify the execution unit or in other words specify a compatible execution unit for each operation. In embodiments there may be more than one execution unit of a given type such as InputReader may have two command queues which can operate concurrently. A NED may specify which of the queues is assigned so that there remains a 1:1 relationship between what the NED specifies and the physical hardware to which it points.

The dataflow and dependencies of the task's graph is described by pipes, which are described in another element as part of the NED: NEDPipeElement. Pipes are used to represent data storage elements within the neural engine 700 and describe the relationship between sections (operations) in a producer-consumer relationship: the output destination pipe (e.g. a pipe number) and each input source pipe (e.g. a pipe number) for every section is defined in the NED elements of the NED. A pipe has only a single producer, but may have multiple consumers. A pipe may be mapped to one of several different locations (e.g storage elements in the neural engine 700), but not all locations may be suitable for the different section operations. It will be appreciated that, in some arrangements, a pipe may be mapped to only a portion of a storage element-e.g. a number of physical buffers, allowing it to describe double-buffering (for example) behavior between its producer and consumers. The output data generated by a section and stored in a pipe is referred to equivalently as both a block (of data) and a (virtual) buffer, with a block of data occupying one physical buffer location. Irrespective of location, pipes may be non-coherent with a wider memory system associated with the neural engine 700 and with processor 630, and data is stored out using the Output Writer element of the neural engine 700.

In some arrangements the NED may be configured such that the same pipe is used for multiple inputs, where any relevant usage constraints (such as format or location) are satisfied. For example, an element-wise multiply might have the same pipe for the two input operands in order to square the input.

In some embodiments, sections such as InputReader and WeightFetcher have no pipes and instead their data comes from external memory, such as an external cache or DRAM. By contrast, some sections, such as OutputWriter have no output pipes. In this case, their data is written to external memory.

For a section to run, it must have all the appropriate buffers available for its input source pipes.

A section may produce a new buffer in its output destination pipe and so there must be space available in the pipe for this new buffer. In the case of a reduction operation (convolution, for example), a section may repeatedly read back and update the previous buffer it generated. As a result, for a reduction operation there is a distinction between the reduction operation having first generated the output buffer and the reduction having completed and the output buffer being fully available, due to this update process. Put another way, there is a point in time at which the output buffer exists in the input pipe of a subsequent operation, but it is not yet ready to be consumed by the subsequent operation. The neural engine 700 is responsible for tracking all of these dependencies, in which buffers are tracked like FIFO entries, but with buffers only available for consumers when a producer has completed any sequence of reductions, and with buffers only freed up when all consumers have completed operations dependent on them.

A task's graph has a directed acyclic dataflow. In this way, in this example it is not legal to use an input pipe as the destination pipe in the same section, or to have any form of loop within the graph. Note that reduction operations will both read from and write to their output destination pipe's buffer, but this is still acyclic behavior; for example, the convolution engine may repeatedly accumulate into the same accumulator buffer.

In this example implementation, the neural engine is stateless between tasks: all control state is encapsulated in the task's NED, and all data is encapsulated in the pipes defined by the NED. There is no sharing of pipes between tasks and therefore no architected sharing of data between tasks within the neural engine 700. Data reuse and sharing is achieved only through memory by use of the Output Writer in a preceding task and the Input Reader in a later task. The neural engine will cache memory descriptors, including the NED, between tasks; this cache is invalidated each time a complete neural workload is completed (e.g. the total neural network and not just the sub-graph associated with a specific task). However, it will be appreciated that this is just an example implementation.

The NED is split into multiple data structures, each defining a portion of an acyclic graph, that may appear contiguously in memory to be read by the neural engine 700. In this example implementation, the NED header defines the dimensions of the operation space of the operations to be performed. Specifically, the NED header defines the total size of the NED (e.g. number of bytes to used to represent the NED) as well as a count of the number of section and pipes that are present in the graph.

For each section and pipe in the graph, a count of a corresponding mapped sub-descriptor element types is represented in the NED header. For instance, where the graph (or sub-graph) contains a number of sections, each of those sections is to be executed on a particular compatible execution unit of the neural engine 700. For each section, an element of the appropriate type is therefore counted in the NED header in order to represent the hardware requirements needed to invoke execution of the graph. For example, for a section that defines a convolution operation, a corresponding configuration and invocation of a convolution engine execution unit would be required. Similar counts of instantiations of weight fetch and input read execution units are counted based on the presence of sections that use those operations. This is reflected in the count in the NED header against the weight fetch and input reader elements associated with the weight fetch and input reader units in the neural engine 700.

The NED also contains information that describes any divergent or convergent branches between sections and pipes. For example the NED identifies, for each pipe in the graph, the number of producers and consumers associated with that pipe.

The NED header therefore essentially identifies the operation space and a count of all instances of sections and pipes (for each type of hardware element that is to be allocated for instantiating a section or a pipe that will be required to execute the graph (or sub-graph)) defined by the NED. An illustrative example of at least a portion of the fields stored in the NED header is set out below. In addition to the NED header, the NED further comprises sub-descriptor elements (defining either the configuration of an execution unit or storage element to operate as a section or pipe) for each instance of a section and/or pipe. Each sub-descriptor element defines the configuration of the associated hardware element (either execution unit or storage element) required to execute the section and/or pipe.

An example of at least some of the fields in a NED header is set out below:

| Field | Min | Max |
|---|---|---|
| Operation space size for dimension 1 | — | — |
| Operation space size for dimension 2 | — | — |
| Operation space size for dimension 3 | — | — |
| Operation space size for dimension 4 | — | — |
| Operation space size for dimension 5 | — | — |
| Operation space size for dimension 6 | — | — |
| Operation space size for dimension 7 | — | — |
| Number of weight fetch and decode | 0 | 1 |
| sections | | |
| Number of input reader sections | 1 | 7 |
| Number of output write sections | 1 | 7 |
| Number of convolution engine sections | 0 | 1 |
| Number of transform unit sections | 0 | 7 |
| Number of vector engine sections | 0 | 7 |
| Number of pipes | 1 | 15 |

The theoretical minimum and maximum operation space dimension sizes may be defined at compilation based on the configuration of the neural engine, specifically such that the operations of the task (e.g. sub-graph) can be performed without requiring intermediate data to be stored in a memory element outside of the neural engine. A practical approach to defining a task and its corresponding operation space is set out in more detail later.

The NED header may also comprise pointers to each of the sub-descriptor elements to enable the specific configuration of each element to be read by the handling unit 720.

As mentioned, each instance of the sub-descriptor element defines a configuration of the hardware element (e.g. execution unit or storage element) to which it relates. The following description will provide an example sub-descriptor for a convolution engine.

In an example, the convolution engine is an execution unit which is configured, when invoked, to perform a convolution or pooling operation selected from one or more convolution operations for which the convolution engine is configured. One such example is a 2D convolution operation as described above. In the example of the 2D convolution operation described above, the operation space is 7D—namely [oc, n, oy, ox, ic, ky, kx].

Field
Stride X and Stride Y
Dilation X and Dilation Y
Operation type (e.g. which type of
convolution operation is to be performed)
Input width and height
Pad Left
Pad Top
Source 0 pipe (input feature map pipe)
Source 1 pipe (weight pipe)
Destination pipe

In this example, the operation type may for example take the form of one of pooling (average or max pooling), 2D convolution, or 2D depth-wise convolution. The source 0 pipe field might identify from which pipe the convolution engine should read the input feature map data—this may for example be a specific portion of a shared buffer. Similarly the source 1 pipe field might indicate from which (different) portion of the shared buffer the weight data is to be retrieved. Finally, the destination pipe might indicate that an accumulation buffer is to act as the pipe for the output of the operation performed by the convolution engine. By identifying for a section specific source and/or destination pipes, which have unique identifiers in the task definition (the NED), any preceding or subsequent sections are implicitly connected and sequenced. Another sub-descriptor element referencing the destination pipe of a different section as a source pipe will inherently read that data and the buffer allocation for that destination pipe may only be released once all of the dependencies have been resolved (e.g. that the sections that rely on that portion of the accumulation buffer have all completed reading that data).

Similar sub-descriptor elements exist for all sections based on configuring the execution units to perform operations. For example, sub-descriptor elements may define destination and source pipes, a pointer to a transform from operation to section space, and a mode of operation for the section.

In this example implementation, pipes represent all storage within the neural engine: all allocation and memory management is handled through a task's NED Pipe definitions and the traversal through the sections that produce and consume these pipes. There is no sharing of pipes between tasks and therefore no architected sharing of data between tasks within the neural engine. A sub-descriptor element is defined in the NED for each pipe in the graph. An example of a pipe sub-descriptor is set out below:

| Field | Min | Max |
|---|---|---|
| Pipe location (e.g. accumulator buffer, | 0 | 2 |
| shared buffer, LUT memory) | | |
| Number of buffers occupied by the pipe | 1 | 16 |
| Starting bank in memory | 1 | 8 |
| Number of banks used by the pipe | 1 | 8 |
| Starting word | 0 | 255 |
| Number of words per buffer | 1 | 256 |

These descriptors are used to configure the hardware elements when invocation is triggered by the handling unit 720.

### Neural Engine Task Dimensions and Iteration

A neural engine task describes a 4D bounding box (dimensions #0-3) that should be operated on by the section operations of a graph defined by a NED that the task provides a pointer to. As well as describing the graph, the NED also defines a further four dimensions (dimensions #4-7), making for a total 8-dimension operation-space. The bounding box for the first four dimensions is a sub-region of the full size of these dimensions, with different tasks and/or jobs covering other sub-regions of these dimensions. The command processing unit 640 may issue different tasks to different neural engines. As such, the dimensions 0-3 when the NED is generated or at the point that the task is defined. The latter four dimensions are described in their entirety in the NED and are therefore covered entirely in each task. The NED additionally defines an increment size for each of these 8 dimensions to be stepped through, known as a block size. Execution of the graph against this 8D operation-space can be considered as a series of nested loops.

This splits the execution of the task's operation-space into a series of blocks, with sections being invoked on a block-by-block basis, operating on a block's worth of data in every source and destination pipe. Consequently, defining a general operation space in a coordinate system having for example eight dimensions may provide a low complexity pattern for execution of any task comprising operations on data, instead of relying on fixed functions per task type, which may encompass a significant risk of missing necessary combinations of patterns. By defining a common operation space in a coordinate space, it may be less complex to chain a plurality of operations to be executed on data to each other and coordinate execution of these functions. Operation space dimensions does not have a specific interpretation until they are projected into space for a specific task.

The number of dimensions in use is dependent on the graph and its operations; not every section will run for increments in each dimension. For example, a convolution operation has a 7D operation-space but only a 4D output space through which the convolution operation increments and accumulates output; a VE scaling operation following a convolution thus only runs for increments in the first four dimensions. This relationship is described by two variables, the number of operation-space dimensions triggering increments for each section, dims_inc_run (a “dimensions increment run” value), and the number of operation-space dimensions generating new blocks for each pipe. “dims_inc_buf” (a “dimensions increment buffer” value), both of which are encoded in their respective NED elements. Both fields are specified counting dimensions from the outer-most dimension #0 up to the inner-most dimension #7.

dims_inc_run specifies how many operation-space dimensions trigger invocations of the section when those dimensions increment in operation-space.

Example usage of dims_inc_run is illustrated below:

0: the section is independent of the operation-space and will therefore only be invoked once for the task;
1: the section may depend on operation-space dimension #0, and is invoked for each operation-space step through dimension #0; and
8: the section may depend on all operation-space dimensions, and is invoked for each operation-space step.
dims_inc_buf specifies how many operation-space dimensions generate a new block in the pipe when those dimensions increment in the producer section, effectively defining how many blocks the pipe generates throughout the duration of the task;
if the value of dims_inc_buf is k (where k>0), then pipe.blocks=dim[0].blocks*dim[1].blocks* . . . *dim[k−1].blocks;
if the value of dims_inc_buf is k (where k==0), then the pipe only ever has a single block
For simple operations, dims_inc_run will be equal to dims_inc_buf for all source input and output destination pipes, but for more complex operations, dims_inc_run may be greater.
Where dims_inc_run>dims_inc_buf:
for a source pipe: this relationship between the fields indicates the reuse of a buffer through one or more operation-space dimensions, the difference between the two values specifying the number of reuse dimensions. In this context, reuse means that the data is broadcast through the extra dimensions: the buffer in the Neural Engine's internal memory is consumed multiple times. For example, the feature map input to a convolution operation is typically reused against the weight kernel x and y dimensions of the convolution engine.

Meanwhile, for a destination pipe, this relationship indicates the reduction of one or more operation-space dimensions' set of buffers, the difference between the two values specifying the number of reduction dimensions. In this context, reduction means that the data from the extra inner operation-space dimensions are accumulated in the smaller number of outer operation-space dimensions (with the section reading back and updating its output buffer over multiple invocations). For example, a vector block reduction operation will result in a smaller number of buffer increments.

Where a pipe has multiple consumers, there is no relationship between those consumers and no restriction or requirement on the value of dims_inc_run for a consumer with respect to other consumers.

In the examples described herein, the neural engine's handling unit is responsible for iterating through this 8D operation-space for each section described in the NED graph. The handling unit uses the two values, dims_inc_run and dims_inc_buf, to determine which increments are relevant and to correctly manage the dependencies between the sections and their pipes. Each section operates in its own local coordinate space, known as the section-space, and the handling is responsible for transforming each relevant operation-space block (relevant through an increment in a run dimension) into this section-space. In the examples described herein, this transformation may be programmatic and described with a small program in a specialized (or general purpose) ISA that is executed for each block before the section is invoked.

The handling unit may be synchronizing the execution of multiple different parts of these nested for-loops in parallel, and therefore needs to track where in the loop a function of a component should be invoked, and where in the loop, data that may be needed by subsequent components (based on the partially ordered set of data structures) is produced. To achieve this in a flexible way, which still allows for a straightforward hardware implementation, two types of dimensions are specified in each data structure defining a portion of an acyclic graph.

In some embodiments, each data structure comprises N vectors of binary values indicating, for each of the N dimensions of the coordinates space, whether changes of coordinate in said dimensions while executing the task causes the function of the associated component to execute or not and causes the function of the associated component to store data in the storage or not (DIMS_INC_RUN). Effectively, this allows for the behavior of each component for each dimension is thus encoded as a multi-hot vector of behaviors. Behaviors may include for example reuse, recompute, reduce, output, unmapped/once.

In some types of tasks including operations on data, data is frequently “reused” multiple times over some number of dimensions. For example, in operations in a neural network, same weights may be applied to multiple elements in the Batch, X and Y dimensions of a feature map, but the weights are unique over the input and output channel dimensions. To inform the handling unit about the specifics of each function (based on the task at hand), each data structure may indicate the dimensions of the coordinates space for which changes of coordinate in said dimensions while executing the task causes the function of the associated component to execute.

To save bits and reduce complexity, each data structure may instead comprise a first number indicating the dimensions of the coordinate space for which changes of coordinate in said dimensions while executing the task causes the function of the associated component to execute, such as a number between 0 and N. In case the number is equal to 0 the section is invoked once per task (e.g., when the iteration over the N=>1 dimensional coordinate space starts or ends). This may for example correspond to a function that loads a table to be used in subsequent sub-tasks no matter of coordinate or dimension. In the opposite extreme, the value could be equal to N, which means the function of the component is executed on every iteration of every dimension. The data structure described may be generated by e.g., a compiler connected to the processor, wherein the complier is configured to generate code for the processor to execute. The execution of a neural engine task may be defined by two separate iterative processes implemented in the handling unit. In one process, the handling unit iteratively steps through the task's operation-space in block units as defined by the block size of the NED. In the other process, the handling unit iteratively steps through the dataflow graph defined by the NED and, where permitted by the dimension rules described above, transforms each block into the relevant section-space before invoking the section's execution unit with the transformed block by issuing invocation data.

To implement a reduction operation, the operation-space iteration will issue a sequence of block invocations to an execution unit (e.g. the convolution engine or vector engine) all targeting the same output block. The handling unit will signal when executing the first block in this sequence, and the execution unit must start by initializing the destination buffer (the whole buffer as limited by the block's size as described above), whereas for all subsequent blocks in the sequence the unit will read back the existing values from the buffer. In this way, the destination buffer acts as an additional input to the operation, from the perspective of individual block execution. In the case of the convolution engine, it is possible that one or more reduction dimensions are zero, meaning that no functional operation is required, but the convolution engine must still initialize the destination buffer if it is the first block in the sequence and the block's execution dimensions aren't empty.

When the handling unit invokes an execution unit to execute a block, the handling unit is configured to issue invocation data to execute the operation on a block. The block iteration is defined based on a block size specified in the NED and the issuance of the invocation data is done under the control of the DIMS_INC_RUN value as discussed above. Moreover, it is necessary for any dependencies that need to be met for the execution unit to operate on the block. These include that the required data is stored in the source pipe(s) for the operation and that sufficient storage is available in the destination pipe, as well as that the transform of the operation space to section space for that section has been performed and the output of that transform operation (i.e. the transformed coordinate data) is available to be issued to the execution unit. More specifically, it is to be ensured that there is sufficient availability in the pipe for a new block or buffer. However, this is not needed if this is not the first step in a reduction block, because in this instance the operation may involve simply read-modify-writing a previous destination block/buffer. Determining the availability of a source storage element may involve determining there is an appropriate block/buffer in the source pipe.

The iteration process first involves reading from the NED a block size and iterating through the operation space one block at a time. For each block, a transform program is executed to transform the operation space coordinates to section space coordinates for that section. Once the section space coordinates have been determined, the section operation is performed in respect of that block. This process is iterated over all blocks until the operation is completed for all blocks.

### Selecting a Block Size

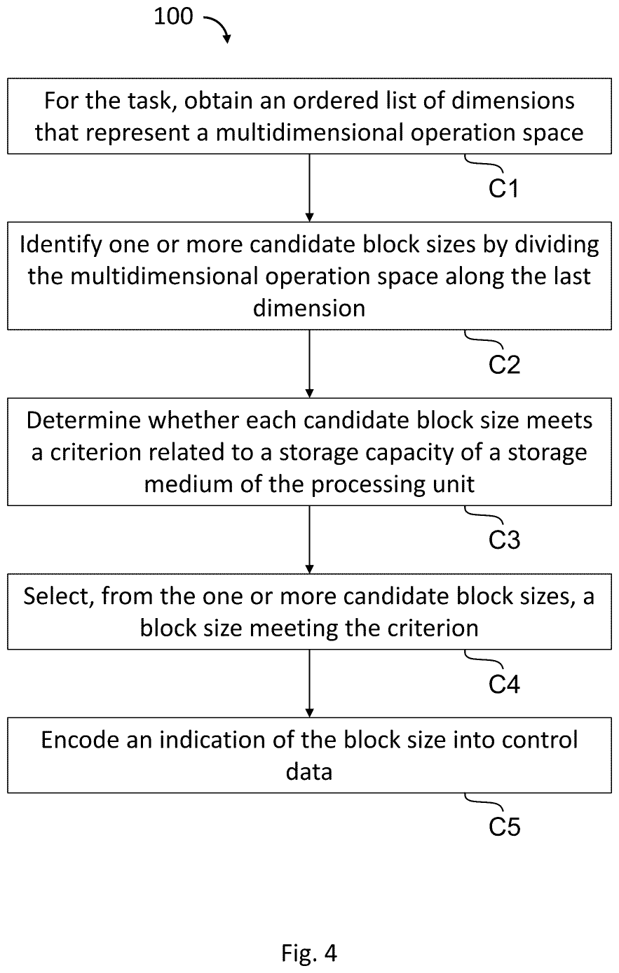

Embodiments of the present invention provide a method for selecting a block size for performing the above-described iteration process, as will now be described with reference to FIGS. 4 to 7b. The method may be performed by a compiler that generates the NED described above. The compiler may be executed on the host processing unit 610 described above. Once a block size has been determined, the block size is encoded in the NED for use by the coprocessor 630 as described above.

FIG. 4 is a flowchart showing steps of a method for determining the block size associated with a task. At step C1, the compiler obtains, for a task, an ordered list of dimensions that represent the multidimensional operation space. The list of dimensions for the multidimensional space is determined based on a dominant operation in the task. In particular, the dominant operation may be determined as the operation in the task that has a largest number of dimensions. In a case in which there are multiple operations with the same number of dimensions, a selection may be made between the operations. For example, there may be a logic that defines which operation type to select.

Each dimension of the multidimensional operation space relates to a dimension of an array of input or output data for at least one of the operations. For example, if one of the operations of the task is the 2D convolution operation described above, the dimensions may comprise an input channel (IC), a kernel dimension X (KX), a kernel dimension Y (KY), an output X (OX), an output Y (OY), a batch (N), and an output channel (OC). As used herein, an “array of input data” is not limited to input feature map data, but may include other inputs used for the operation, such as weight data, for example the kernel dimension X (KX) and the kernel dimension Y (KY). The multidimensional operation space may, therefore, comprise each of the dimensions described above that define the 2D convolution operation.

The list of dimensions are ordered in a predetermined order. The order may be determined based on the type of the dominant operation for the task as described above. Different types of operation may include convolution operation, fully connected layer, and average pooling operation. The list of dimensions are ordered by their impact on performance of the processing unit (such as compute unit 650a or compute unit 650b) when loaded in sections (as described above) from a storage medium (such as local cache 656a or local cache 656b) of the processing unit. A first dimension of the ordered list has a higher impact on performance of the coprocessor 630 than a last dimension on the ordered list.

In some cases, the impact on performance may depend on the re-use rate of a data value from the dimension when processing an operation included in the task. For example, as illustrated in the nested for-loop reproduced below, in a 2D convolution operation, when processing a given output channel OC for a given batch N, the same kernel of weights is used to perform multiply-accumulate operations once for each input channel IC, each output X, and each output Y.

```
for(output channel)
  for(batch N)
    for(output Y)
      for(output X)
        for(input channel)
          for(kernel Y)
            for(kernel X)
              MAC
              write accumulator
```

In the case of a 2D convolution operation, the kernel (weight) dimensions may have a higher impact on performance of the processing unit during processing of the task than the input and output channels, and it is more preferable to divide the multidimensional operation space along the output and input channels than along the kernel dimensions to generate a block size. This may be because the kernel values can be held in local storage and reused across a large amount of input feature map data. For this reason, when the primary operation in the task (the operation that requires the largest number of dimensions of the operation space) is a convolution operation, method 100 may comprise determining, as the predetermined order, an order in which the last dimension in the list is an output dimension (for example, OC, OX or OY) or an input dimension (for example, IC), and in which an earlier dimension in the list is a weight dimension (for example, KX or KY). More generally, where one of the operations in the task comprises a nested loop to be executed by the processing unit, the nested loop comprising loops over a plurality variables in a predefined order, method 100 may comprise determining the predetermined order based on the order in which the variables are looped over in the nested loop, for example determining, as the predetermined order, the order in which the variables are looped over in the nested loop, such that a variable looped over less frequently appears later in the predetermined order. The list of dimensions given in the preceding paragraph provides one specific example of an ordered list of dimensions.

In other examples, if the primary operation in the task is a fully connected layer, a given output value O(o) of an output data channel O is computed as a dot product between a fixed input vector I and a vector of weights for the given output value, W(o). The weights may collectively be described as a matrix W(row #, column #) containing a number of column vectors that is equal to the length of the output data channel. Therefore, to compute all of the output values, while each weight value W(row #, column #) is only multiplied with one element I(i) of the input vector I, each element I(i) of the input vector must be multiplied by the corresponding weight W(row #, column #) from each of the weight vectors. Such a dot product may be represented with the following nested loop.

```
for(weight column #)
  for(weight row #)
    for(input element)
      MAC
      write accumulator
```

In the example of a fully connected layer, the input dimensions, being looped over more frequently than the weight dimensions, have a higher impact on performance of the processing unit during processing of the task than the weight dimensions, and some embodiments may divide the multidimensional operation space along the weight dimensions in preference to the input dimensions when determining a block size. Thus, when the primary task in the operation is a fully connected layer, the method may comprise determining, as the predetermined order, an order in which the last dimension in the list is an input dimension and in which an earlier dimension in the list is a weight dimension.

In addition to the above considerations, it is desirable that a block size is not too short along any given dimension. As mentioned above, the DPU array 730 comprises dot product units. To take an extreme example, if a block has a length of just 1 value along an input dimension, then only one of these dot product units will be able to process the input data before another block needs to be read from the L2 cache 660 to the cache 656a. Similar considerations apply to input data that is processed by other components of the neural engine 700, such as the vector engine 732. The appropriate length of a block to ensure sufficient concurrent use of the dot product units (etc.) depends on the number of dot product units (etc.), but in general a block size that is too short along any given dimension is unlikely to provide fast performance of the coprocessor 630.

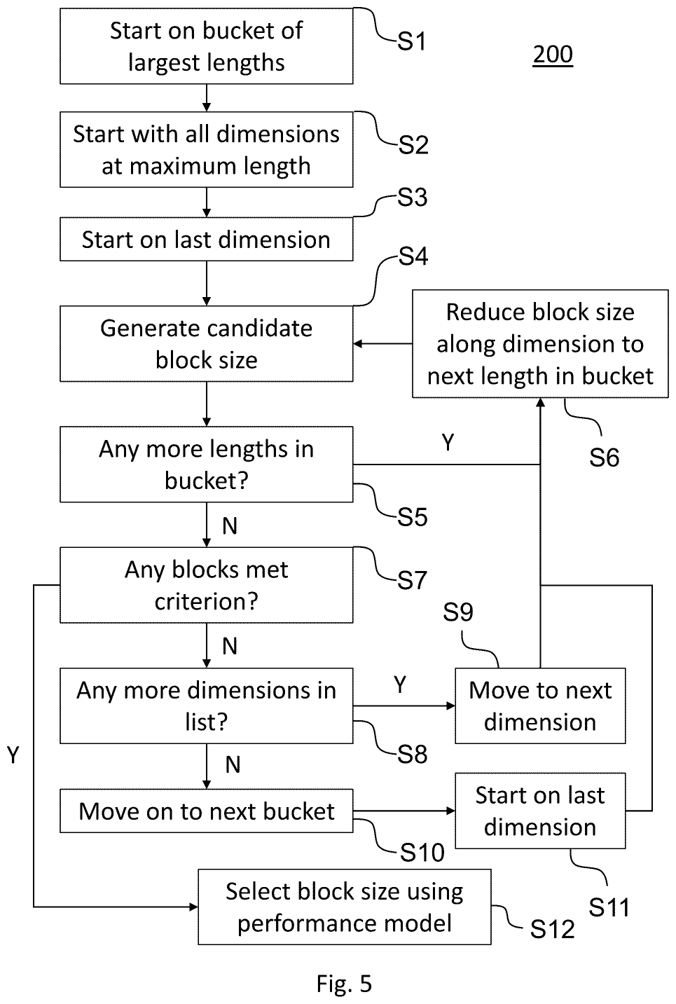

At step C2, method 100 comprises identifying one or more candidate block sizes by dividing the multidimensional operation space along the last dimension. At step C3, method 100 comprises determining whether each candidate block size meets a criterion related to a storage capacity of a storage medium of the processing unit. At step C4, method 100 comprises selecting, from the one or more candidate block sizes, a block size meeting the criterion. We now describe steps C2-C4 in more detail with reference to FIG. 5.

As mentioned above, it is preferable to process input data using a block size which is (a) large, (b) long along dimensions that have a higher impact on performance of the processing unit when processing the task, and (c) not too short along any given dimension. Method 200, which comprises steps C2-C4, is a method for determining such a block size.

FIG. 5 is a flowchart showing a method 200 for determining the block size associated with a task. Method 200 begins at step S1. At step S1, the method 200 comprises selecting a set of one or more candidate lengths referred to as a “bucket” of largest candidate lengths for the block. A “bucket of candidate lengths” as used herein includes, for each dimension of the operation space, at least one length of the operation space along that dimension. The method makes use of two more buckets. The buckets form a sequence of buckets in which the bucket of largest lengths contains longer lengths along each respective dimension than a next bucket. A second bucket of lengths will contain lengths that are shorter than the lengths in the bucket of largest lengths, but which are longer than lengths in a third bucket of lengths. This continues until a bucket of shortest lengths which contains lengths along each dimension that are shorter than lengths in any of the other buckets.

In one example, the bucket of largest lengths includes, for each dimension, the length of the operation space along that dimension. The largest bucket also includes, for each dimension, all lengths that are powers of two, are greater than 8 and less than the length of the operation space along that dimension. For example, if a dimension has an operation space length of 129 values (e.g. if the output channel OC has a length of 129), then the largest bucket will include candidate lengths of 129, 128, 64, 32 and 16 values for that dimension. If a dimension has an operation space length of 15 values, then the largest bucket will include only the candidate length of 15 values for that dimension.

At step S2, method 200 comprises starting to identify a candidate block size with all dimensions on the maximum length. As will be described, method 200 involves gradually reducing the lengths of the block along the operation space dimensions while no block that fits in cache 656a is found. However, as described above, it is preferable to process input data using a block size which is large, so method 200 starts with the largest possible block size.

At step S3, method 200 comprises starting on the last dimension. As will be described, the lengths of the block along the operation space dimensions will be reduced according to the predetermined order described above. However, as described above, it is preferable to process input data using a block size that is long along dimensions that have an impact on performance of the processing unit when processing the task, so method 200 starts by reducing the size of the block along the last dimension, which was identified in the ordered list as having the lowest impact on performance.

At step S4, method 200 comprises generating a candidate block size. The first candidate block size has, for each operation space dimension, a length equal to the length of the operation space along that dimension. In other words, first the entire operation space is tried.

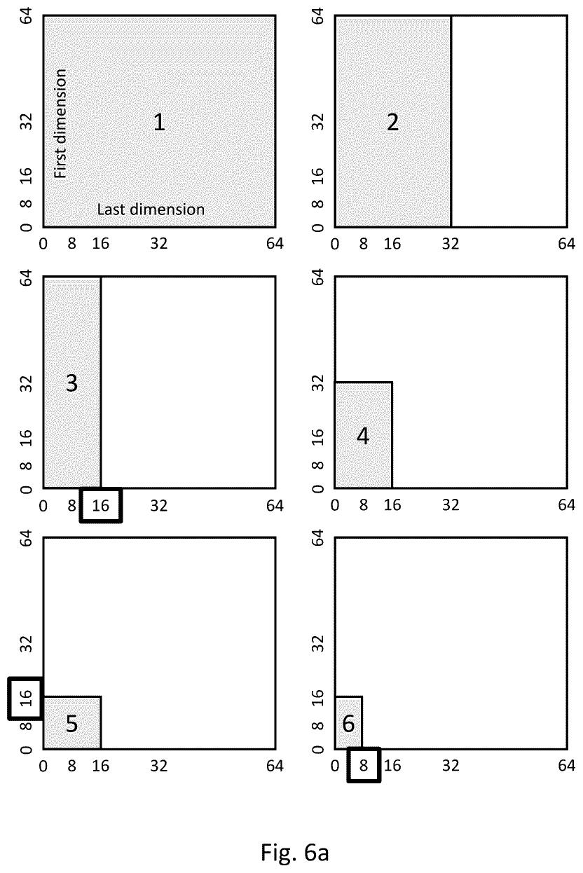

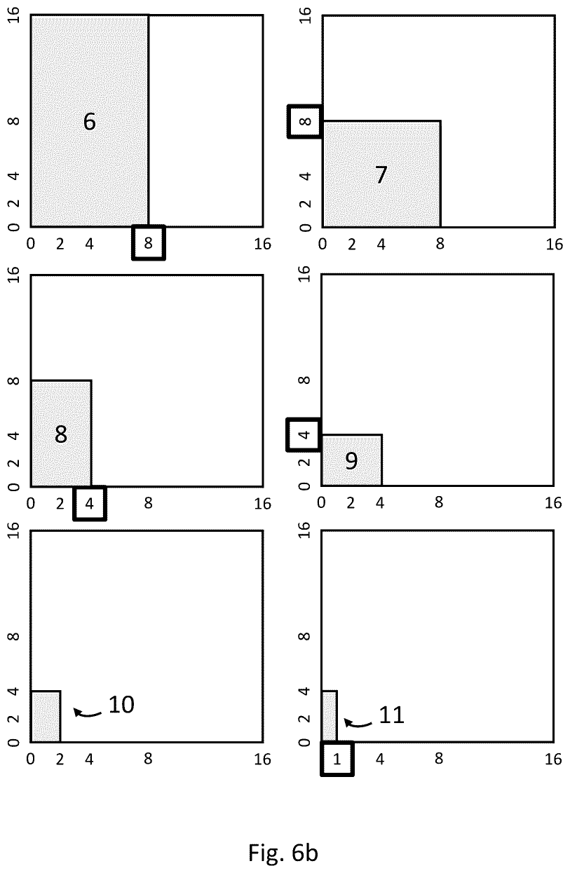

FIGS. 6a and 6b show candidate block sizes generated in a worked example of steps S1 to S11. In the example of FIGS. 6a and 6b, the operation space has just two dimensions for ease of illustration. In general, the operation space may have more dimensions as described above. The first generated candidate block size is labelled 1, and subsequent candidate block sizes are labelled in the order in which they are generated. As noted above, a first candidate block size is the top-left candidate block shown in FIG. 6a.

At step S5, method 200 comprises determining whether there are any more lengths in the bucket for the current dimension (i.e. other than the length used to generate the candidate block size at the previous instance of step S4). At the first instance of step S5, method 200 comprises determining whether there any more lengths in the bucket for the last dimension in the ordered list. In the example of FIGS. 6a and 6b, the length of the operation space along both the first dimension and the last dimension is 64 values. Therefore, in this example, method 200 comprises determining that there is another length in the bucket for the current dimension (the last dimension to begin with) that has not been used in generating a candidate block size, namely the lengths 32 values and 16 values in the present example.

In response to determining that there are more lengths in the bucket for the current dimension, method 200 comprises, at step S6, reducing the block size along the current dimension to the next-lowest length in the bucket. In the example of FIGS. 6a and 6b, the last dimension is reduced from 64 values to 32 values.

In the example of FIGS. 6a and 6b, method 200 returns to step S4, and comprises generating a candidate block size with the current dimension having the next-lowest length in the bucket. This candidate block size is shown by the candidate block size labelled 2.

In the example of FIGS. 6a and 6b, steps S5, S6 and S4 are repeated to generate the candidate block size labelled 3.

In response to determining that there are no more lengths in the bucket for the current dimension, method 200 comprises, at step S7, determining whether each of the generated candidate block sizes meets a criterion related to a storage capacity of the cache 656a (or 656b) of the processing unit. In method 200, the criterion is whether both input and output data included in the candidate block size can be processed by the processing unit without exceeding the storage capacity of the storage medium of the processing unit. For example, if the block dimensions consist of an input dimension, a weight dimension, and an output dimension, then a candidate block size will only meet the criterion if a data array with the candidate block size including the input, weight and output data can be stored in the cache 656a of the processing unit without exceeding a memory capacity of the cache 656a. However, in some examples, the criterion may only relate to input data, i.e. if a data array with the input and weight data can be stored in the cache 656a without exceeding the memory capacity, then the criterion is met, irrespective of whether the output data can also be stored in the cache 656a without exceeding the memory capacity. For example, the output data may be stored in a memory element other than the cache 656a, e.g. it might be written directly to L2 cache 660 after being generated from the input data.

In the example of FIGS. 6a and 6b, the lowest candidate length in the largest bucket, 16, is shown by a black square outline. In this worked example, it is determined that the criterion is not met by any of blocks 1, 2 or 3.

In response to determining that none of the generated candidate block sizes meet the criterion, method 200 comprises, at step S8, determining whether there are any more dimensions in the ordered list with lengths in the current bucket that have not yet been used to generate a candidate block size. In the example of FIGS. 6a and 6b, method 200 comprises determining that there are lengths in the largest bucket for the first dimension (illustrated on the vertical axis) that have not yet been used to generate a candidate block size.

In response to determining that there are one or more dimensions in the ordered list with lengths in the current bucket that have not yet been used to generate a candidate block size, method 200 comprises, at step S9, moving to the next dimension in the ordered list. In response to moving to the next dimension, the method comprises returning to step S6, and reducing the block size along the next dimension to the next length in the bucket. Steps S4-S9 may be repeated appropriately as long as no blocks meet the criterion. In the example of FIGS. 6a and 6b, the length of the block size along the first dimension is reduced firstly to 32 values (the block labelled 4) and subsequently to 16 values (the block labelled 5).

Provided that no blocks have met the criterion in step S7, if, at step S8, it is determined that there are no more dimensions in the list with lengths in the current bucket that have not yet been used to generate a candidate block size, method 200 comprises, at step S10, moving on to the next bucket in the sequence of buckets. In method 200, as stated above, the largest bucket includes, for each dimension, the length of the operation space along that dimension and any lengths that are powers of 2 between 16 and the length of the operation space along that dimension. In method 200, by way of example the second bucket (second-largest bucket) includes, for each dimension whose operation space length is 16 or greater, the lengths of 16 and 8 data values. The second bucket includes, for each dimension whose operation space length is less than 16 but no less than 8, the operation space length and (if different) the length of 8 data values. The second bucket includes, for each dimension whose operation space length is less than 8 values, the operation space length.

Method 200 comprises, at step S11, in response to moving on to the next bucket, starting on the last dimension. From here, the method returns to step S6. In the example of FIGS. 6a and 6b, steps S4 to S9 are repeated as shown by the block sizes labelled 6 and 7.

Provided that no block size meets the criterion in step 7, steps S4 to S11 are repeated. In the example of method 200, the third bucket (third-largest bucket) includes, for each dimension whose operation space length is 8 or greater, the lengths of 8 and 4 data values. The third bucket includes, for each dimension whose operation space length is less than 8 but no less than 4, the operation space length and (if different) the length of 4 data values. The third bucket includes, for each dimension whose operation space length is less than 4 values, the operation space length. In the example of FIGS. 6a and 6b, steps S4 to S11 are repeated as shown by the block sizes labelled 8 and 9.

By arranging the lengths in the buckets as powers of two, an efficient method for identifying a block that meets the storage criterion can be provided.

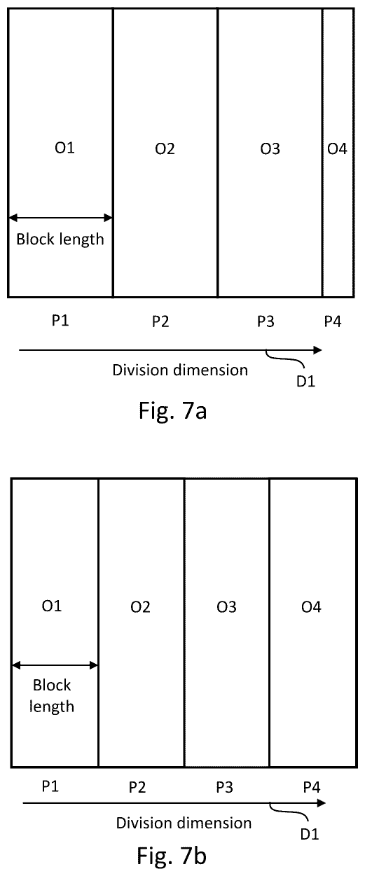

If, at step S7, it is determined that any blocks meet the criterion related to the storage capacity of the processing unit then the method proceeds to step S12. In some embodiments, the method 200 may comprise determining at step S7, in addition to the block sizes determined in steps S1-S11, one or more core-optimized candidate block sizes, as will be described with reference to FIGS. 7a and 7b. As mentioned above, the coprocessor 630 comprises a plurality of compute units 650a, 650b, also referred to as processing cores, each comprising their own cache 656a, 656b. The number of processing cores may vary from coprocessor to coprocessor. In the following example, there are four processing cores, but this may vary from implementation-to-implementation. The method 200 may comprise dividing the multidimensional operation space perpendicular to one or more division dimension D1 of the operation space to obtain divided portions O1-O4, and allocating the divided portions O1-O4 of the operation space to respective processing cores P1-P4. Ideally, when dividing along a single dimension, the length of the divided portion along the division dimension would be an integer multiple of the block length along that dimension, as illustrated in FIG. 7b. If this is not the case, as illustrated in FIG. 7a then at least one processing core (P4 in FIG. 7a) would have to process a block that is shorter than the selected block size, so as not to duplicate the work of another processing core (i.e. not to overlap with the portion of the operation space that is to be processed by another processing core). The method outlined so far in steps S1-S11 does not guarantee that there will be any dimension that has this property.

For this reason, method 200 may comprise determining one or more core-optimized candidate block sizes. Once the method 200 has determined non-core-optimized candidate block sizes according to steps S1-S11 outlined above, the method 200 may comprise determining one or more division dimension along which to divide the operation space. The method then comprises dividing the length of the operation space along the one or more division dimensions by the number of processing cores to determine the maximum length of the core-optimized candidate block size along that dimension or dimensions. The lengths for each affected dimension in the buckets of lengths may then be amended accordingly, to include the maximum length of the core-optimized candidate block size and to remove lengths that are longer than this maximum length. Then, steps S1-S11 can be re-run with the new lengths, to determine a set of core-optimized candidate block sizes. Subsequently, the lengths for each affected dimension in the buckets of lengths may be amended further, by identifying a shorter length for the affected dimension. For example, the maximum length for that dimension may be factorized to determine a shorter length. For example, if the maximum length (found by, for example, dividing the length of the operation space along the dimension by the number of processing cores) is 15 values, then a shorter length may be identified as 5 values. The lengths that are longer than this shorter length may be removed from the buckets, and steps S1-S11 may be re-run, to add more core-optimized candidate block sizes to the set.

The method may then comprise determining a further division dimension along which to divide the operation space, and performing the above-mentioned steps to determine a further set of core-optimized candidate block sizes. The one or more division dimensions may be determined according to alignment constraints. For example, a data layout format may define groups of data values for a certain dimension, whereby one group cannot be split among multiple blocks. If the data values are in groups of, for example, 5 values for a particular dimension, it may not be possible to divide the operation space so that it consists of portions which have lengths of less than 5 values along that dimension. Method 200 then comprises selecting one of the core-optimized candidate block sizes in step S12. By selecting a core-optimized candidate block size, the processing of the operation can be divided evenly between the processing cores, which may enable improved parallelization of the processing and reduction in the total processing time. Furthermore, the division of the operation space along the division dimension, and the associated reduction in block size along this dimension, may enable a block to be generated which is longer along other dimensions.

To identify a selected block size, method 200 comprises, at step S12, selecting a block size from among the candidate block sizes (and optionally the core-optimized candidate block sizes) using a performance model. The performance of a block size to be used depends on various parameters of the processing unit (e.g. the number of dot product units, the number of processing cores, the availability of memory in input buffers).

In the worked example of FIGS. 6a and 6b, it is identified that the block sizes labelled 10 and 11 both meet the criterion in step S7. As a result, step S8 is not performed subsequent to this, and the block size is not reduced further along the first dimension. Instead, block sizes 10 and 11 are provided to the performance model.

In method 200, selecting a block size using the performance model comprises simulating an execution of the task using one or more candidate block sizes meeting the criterion, to determine, for each candidate block size meeting the criterion, a processing performance parameter. For example, method 200 may comprise determining, as the processing performance parameter, a number of cycles of a timing signal that the processing unit 650a will use to process the block. As mentioned above with reference to FIG. 2, due to the limited capacity of components in a processing unit (such as a vector engine 732, or the dot product units in a DPU array 730), even if the storage of the processing unit (e.g. cache 656a) is capable of storing all of the inputs, weights and outputs for an operation, the processing unit 650a may have to process the block in multiple stages. In order to determine the number of cycles required, it is not necessary to actually use the processing unit to, for example, process a trial block of data. Rather, the number of cycles required can be calculated based on the data handling capacities of the components in the processing unit, which may be known parameters. For example, if it is known that the dot product units of the DPU array 730 are capable of collectively and simultaneously processing a predefined number of dot products in a known number of cycles, then the time required for processing by the dot product units can be determined. Similar determinations may be made for the time required to retrieve input feature map data and to store the output feature map data.

Alternatively, however, simulating the execution may comprise processing a trial block with the candidate block size using the processing unit 650a, and measuring a performance parameter such as the time taken to process the block. The trial block may include, for the input dimensions, random noise data.

In any case, as the task may comprise a plurality of operations, such as the chain of operations illustrated in FIG. 1, simulating the execution of the task may comprise simulating an execution of each of the operations according to the methods described with reference to FIGS. 1b and 2. For example, the chain of operations may be represented as a command stream which is received by the processor 630. The handling unit 720 of the neural engine 700 (processing module 656a) may split data representing a feature map in accordance with the candidate block size. The handling unit 720 may then coordinate the interaction of the internal components of the neural engine 700 to execute the task.

In any case, method 200 comprises selecting, based on the processing performance parameters, a candidate block size. For example, the candidate block size may be selected based on the candidate block size with the lowest number of cycles taken to process the task.

Returning to FIG. 4, in method 200, steps C2-C4 have been performed in accordance with the method illustrated in FIG. 5. At step C5, method 100 comprises encoding an indication of the selected block size into the NED control data to allow the processing unit to retrieve portions of input data as described above. The portions of input data retrieved by the coprocessor 630 correspond to input data included in a block in the multidimensional operation space obtained by traversing the multidimensional operation space with the selected block size. In particular, the input data may be obtained by an affine or semi-affine transform as described above.

Method 200 may comprise sending the control data to the processing unit. During processing of the neural network, the coprocessor 630 retrieves the portions of input data based on the control data. For example, the control data may indicate that, for a convolution operation, the block size to be used is as shown in Table 2. The processing unit may then retrieve input data from memory 660 according to this block size. For example, the processing unit may retrieve the entire 3×3 kernel, and an array of input feature map data with dimensions OC=16, N=1, OY=8, OX=8, and IC=16, for example Block #0 shown in Table 3. The processing unit may then process this data using neural engine 700, as described above. The neural engine 700 may, on the basis of the processing, generate output data with dimensions OC=16, N=1, OY=8, OX=8, and IC=16. The output data may then be written to L2 cache 660. Blocks #1 to #7 in Table 3 may be processed in turn, in a similar fashion. Thus, the multidimensional operation space may be traversed with the selected block size.

Methods 100 and 200 may be performed by a processor such host processor 610. The processor may perform methods 100 and 200 by executing instructions of a program. The program may be stored in a non-transitory computer-readable medium.

The above embodiments are to be understood as illustrative examples of the invention. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

What is claimed is:

1. A method of determining a block size associated with a task to be processed by a processing unit, wherein the task includes one or more operations, the method comprising:
for the task, obtaining an ordered list of dimensions that represent a multidimensional operation space, wherein:
each dimension of the multidimensional operation space relates to a dimension of an array of input or output data for an operation of the one or more operations,
the list of dimensions are ordered in a predetermined order, and
the list of dimensions has a first dimension that has a higher impact on performance of the processing unit when loaded in sections along the first dimension from a storage medium of the processing unit during processing of the task by the processing unit than a last dimension in the list;
determining a block size by:
identifying one or more candidate block sizes by dividing the multidimensional operation space along the last dimension,
determining whether each candidate block size meets a criterion related to a storage capacity of the storage medium of the processing unit, and
selecting, from the one or more candidate block sizes, a block size meeting the criterion; and
encoding an indication of the selected block size into control data to allow the processing unit to retrieve portions of input data corresponding to input data included in a block in the multidimensional operation space obtained by traversing the multidimensional operation space with the selected block size.

2. The method of claim 1, wherein the one or more candidate block sizes are identified using a first set of one or more candidate lengths and a second set of one or more candidate lengths that are shorter than the candidate lengths in the first set, wherein identifying one or more candidate block sizes comprises, for candidate lengths from the first set of one or more candidate lengths identifying a first set of candidate block sizes having the candidate length along the last dimension, and
in response to determining that the first set of candidate block sizes do not meet the criterion, for the candidate lengths in the second set of one or more candidate lengths identifying a second set of candidate block sizes having the candidate length along the last dimension.

3. A method according to claim 2, wherein identifying the first set of candidate block sizes comprises identifying candidate block sizes having a candidate length from the first set of one or more candidate lengths by applying candidate lengths to successive dimensions in the list of dimensions from the last dimension to the first dimension, wherein the method identifies one or more candidate block sizes for a next dimension in the list of dimensions if the method determines that none of the current identified candidate block sizes meets the criterion related to a storage capacity of a storage medium of the processing unit.

4. A method according to claim 3, wherein the method identifies the second set of candidate block sizes if the first set of candidate blocks sizes do not meet the criterion after candidate block sizes have been identified for all dimensions on the list of dimensions using the first set of one or more candidate lengths.

5. A method according to claim 2, wherein each candidate length in the first set of one or more candidate lengths and the second set of one or more candidate lengths is a power of two.

6. A method according to claim 1, wherein a length of each dimension of the multidimensional operation space is equal to a maximum dimension of a corresponding array of input or output data used in the operation of the one or more operations.

7. The method according to claim 1, wherein selecting a block size meeting the criterion comprises:
simulating an execution of the task using one or more candidate block sizes meeting the criterion, to determine, for each candidate block size meeting the criterion, a processing performance parameter; and
selecting, based on the processing performance parameters, a candidate block size as the block size.

8. The method according to claim 1, wherein:
the processing unit comprises a plurality of processing cores,
the storage medium is one of a plurality of storage media belonging respectively to the processing cores,
identifying the one or more candidate block sizes comprises dividing the multidimensional operation space or the block size along a dimension from the list of dimensions based on the number of processing cores to determine one or more core-optimized candidate block sizes, and
selecting the block size comprises selecting one of the core-optimized candidate block sizes.

9. The method according to claim 8, wherein dividing the multidimensional operation space or block size comprises dividing the length of a dimension of the multidimensional operation space by the number of processing cores.

10. The method of claim 8, wherein the core-optimized candidate block sizes include block sizes obtained by dividing the multidimensional operation space or block size along two or more dimensions from the list of dimensions based on the number of processing cores.

11. The method according to claim 1, wherein the task is processing of at least a portion of a neural network.

12. The method according to claim 11, wherein the operation of the one or more operations is a convolution operation.

13. The method according to claim 12, wherein the first dimension on the list of dimensions relates to a dimension of weight data.

14. The method according to claim 1, wherein the input data comprises input feature map data and weight data for a neural network.

15. The method according to claim 1, wherein the predetermined order of the list of dimensions is selected based on a type of the operation of the operation of the one or more operations included in the task.

16. The method according to claim 1, wherein the criterion is whether input data included in the candidate block size can be processed by the processing unit without exceeding the storage capacity of the storage medium of the processing unit.

17. The method according to claim 1, wherein the task forms a graph comprising a plurality of operations.

18. The method according to claim 1, further comprising sending the control data to the processing unit.

19. A system comprising a first processing unit, the first processing unit being configured to perform a method of determining a block size associated with a task to be processed by a second processing unit, wherein the task includes one or more operations, the method comprising:
for the task, obtaining an ordered list of dimensions that represent a multidimensional operation space, wherein:
each dimension of the multidimensional operation space relates to a dimension of an array of input or output data for an operation of the one or more operations,
the list of dimensions are ordered in a predetermined order, and
the list of dimensions has a first dimension that has a higher impact on performance of the second processing unit when loaded in sections along the first dimension from a storage medium of the second processing unit during processing of the task by the second processing unit than a last dimension in the list;
determining a block size by:
identifying one or more candidate block sizes by dividing the multidimensional operation space along the last dimension,
determining whether each candidate block size meets a criterion related to a storage capacity of the storage medium of the second processing unit, and
selecting, from the one or more candidate block sizes, a block size meeting the criterion; and
encoding an indication of the selected block size into control data to allow the second processing unit to retrieve portions of input data corresponding to input data included in a block in the multidimensional operation space obtained by traversing the multidimensional operation space with the selected block size.

20. A non-transitory computer-readable medium comprising instructions which, when executed by a first processing unit, cause the first processing unit to perform a method of determining a block size associated with a task to be processed by a second processing unit, wherein the task includes one or more operations, the method comprising:
for the task, obtaining an ordered list of dimensions that represent a multidimensional operation space, wherein:
each dimension of the multidimensional operation space relates to a dimension of an array of input or output data for an operation of the one or more operations,
the list of dimensions are ordered in a predetermined order, and
the list of dimensions has a first dimension that has a higher impact on performance of the second processing unit when loaded in sections along the first dimension from a storage medium of the second processing unit during processing of the task by the second processing unit than a last dimension in the list;
determining a block size by:
identifying one or more candidate block sizes by dividing the multidimensional operation space along the last dimension,
determining whether each candidate block size meets a criterion related to a storage capacity of the storage medium of the second processing unit, and
selecting, from the one or more candidate block sizes, a block size meeting the criterion; and
encoding an indication of the selected block size into control data to allow the second processing unit to retrieve portions of input data corresponding to input data included in a block in the multidimensional operation space obtained by traversing the multidimensional operation space with the selected block size.
